(19) United States
(12) Patent Application Publication
(10) Pub. No.: US 2025/0011953 A1
(43) Pub. Date: Jan. 9, 2025

(54) SITU CATALYST SYNTHESIS, DEPOSITION AND UTILIZATION

(71) Applicant: AVIUM LLC, Lawrence, KS (US)

(72) Inventors: Joseph Mohammad BARFOROUSH, Lawrence, KS (US); Kristen Taylor HIETALA, Lawrence, KS (US); Mark Alan DAUGHERTY, Wauwatosa, WI (US)

(21) Appl. No.: 18/766,322

(22) Filed: Jul. 8, 2024

Related U.S. Application Data
(60) Provisional application No. 63/525,273, filed on Jul. 6, 2023.

(51) Int. Cl. C25B 11/052; C25B 1/04; C25B 11/089; C25D 3/56

(52) U.S. Cl. CPC C25B 11/052; C25B 1/04; C25B 11/089; C25D 3/562

(57) ABSTRACT

Disclosed herein is an electrolyte comprising H+ or OH− and precursors used to make a hydrogen evolution electrocatalyst, an oxygen evolution electrocatalyst, a bifunctional hydrogen/oxygen evolution electrocatalyst, or any combination thereof for use in in situ catalyst synthesis, deposition and/or utilization.

### CROSS-REFERENCE TO RELATED APPLICATIONS

The present application claims priority to U.S. Patent Application No. 63/525,273 filed Jul. 6, 2023, the entire contents of which are hereby incorporated by reference.

### FIELD OF THE INVENTION

The disclosed technology is generally directed to methods and systems for preparation and use of electrocatalysts. More particularly the technology is directed to methods and systems for maintaining high efficiency hydrogen production from water and for servicing an electrolyzer stack.

### BACKGROUND OF THE INVENTION

The development of efficient, earth-abundant electrocatalysts for the water splitting reactions, i.e., the hydrogen evolution reaction (HER) and the oxygen evolution reaction (OER), is of great importance as the world switches to a carbon free economy. In an electrolyzer, the HER occurs on a cathode electrode while the OER occurs on an anode electrode. Earth-abundant catalysts that do not contain Platinum Group Metals (PGMs) are lower cost and have less supply chain risks than catalysts that use PGMs. Improvements in electrocatalysts that increase the efficiency of water splitting translate directly into lower hydrogen production costs which will accelerate the decarbonization of global energy systems.

Traditionally, electrodes are coated with electrocatalysts prior to assembly of an electrolyzer stack, which consists of repeating cells comprising a cathode electrode and an anode electrode with a separator in between the anode and cathode and a bipolar plate between cells. Once integrated with the balance of plant for operation, the stack is typically non-serviceable and must eventually be replaced entirely due to decrease in efficiency over time. Typical stack replacement intervals for alkaline electrolyzers are in a range of 60,000 h to 100,000 h. The end of life for a stack is typically marked by a degradation in efficiency to below approximately 90% of the initial value. Replacement of stacks is a significant capital cost. Stack replacement also requires the electrolyzer to be shut down, disassembled, and reassembled. Therefore, methods and systems for maintaining high efficiency and for servicing a stack without needing to shut down, disassemble, or reassemble the stack or the electrolyzer are needed.

### BRIEF SUMMARY OF THE INVENTION

Disclosed herein are methods, systems, and compositions for synthesizing electrocatalysts inside of an electrolyzer stack (in situ electrocatalyst synthesis) and for reactively depositing electrocatalysts on the electrodes inside of an electrolyzer stack (in situ reactive deposition). One aspect of the technology provides for a method for depositing electrocatalysts. The method may comprise introducing into an alkaline electrolyzer an electrocatalyst precursor, wherein the alkaline electrolyzer has an electrolyte comprising OH− and one or more electrodes. Suitably, a current is applied to the one or more electrodes during introduction of the electrocatalyst precursor solution. Additionally, or alternatively, wherein a current is applied to the one or more electrodes prior to and during introduction of the electrocatalyst precursor solution without interrupting application of the current to the one or more electrodes.

Another aspect of the technology provides for a method for depositing electrocatalysts where the method comprises mixing an electrocatalyst precursor with an electrolyte comprising OH− and contacting the resulting mixture with one or more electrodes having a current applied thereto. Suitably, the electrocatalyst precursor and the electrolyte are mixed in an alkaline electrolyzer comprising the one or more electrodes having the current applied thereto.

In the disclosed methods, the electrocatalyst precursor comprises a metal nitrate, a metal sulfate, a metal acetate, a metal chloride, a metal sulfamate, or any combination thereof. Suitably, the electrocatalyst precursor comprises Fe, Ni, Co, Cr, Cu, or any combination thereof. Exemplary electrocatalyst precursors include an aqueous solution of Fe (III) nitrate, Ni (II) nitrate, Co (II) nitrate, Cr (III) nitrate, Cu (II) nitrate, Fe (II) chloride, Ni (II) chloride, Co (II) chloride, Ni (II) acetate, Co (II) acetate, Ni (II) sulfamate, Fe (II) sulfamate, Co (II) sulfamate, Ni (II) sulfate, Fe (III) sulfate, Cu (II) sulfate, Co (II) sulfate, or Cr (III) sulfate, or any combination thereof.

Additional aspects of the invention include alkaline electrolyzers, reactor systems, and compositions that may be used in the methods described herein.

These and other aspects of the invention will be further described herein.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

In order to simplify terminology, as used herein, an electrode on which the OER will occur during normal water splitting operation is referred to as an anode electrode and an electrode on which the HER will occur during normal water splitting operation is referred to as a cathode electrode. For purposes of catalyst formation or deposition, a positive or a negative potential may be applied to either a cathode electrode or an anode electrode.

Unless otherwise noted, all data sets shown were conducted at a current density of 0.3 A cm⁻² and 80° C. at atmospheric pressure with aqueous 30 wt % KOH as the electrolyte (prior to addition of catalyst precursors if any were added). In the figures our convention is to use “NiFe nitrate” for example, to refer to the use of Ni nitrate and Fe nitrate as catalyst precursors.

FIG. 1: An illustration of an alkaline electrolyzer cell.

FIG. 2A: An illustration of an arrangement of electrodes in alkaline electrolysis cell.

FIG. 2B: A top-view schematic of a Separator Electrode Assembly (SEA), including an electrically conducting mesh electrode 110, a separator 100 which prevents product gases from mixing and allows ion transport between anode and cathode, and catalyst 120 coating both the electrode and the separator.

FIG. 2C: A cross-sectional schematic of a Separator Electrode Assembly (SEA), including an electrically conducting mesh electrode 110, a separator 100, and catalyst 120 coating both the electrode and the separator.

FIG. 3: Diagram of Configuration 1 where catalyst precursors are mixed with electrolyte, then pumped through the system using one pump, and is effective in improving performance of the OER, the HER or both the OER and HER. The improvement in performance is due to in situ formation of catalysts and in situ reactive deposition of catalysts on the electrodes and/or separator.

FIG. 4: Diagram of Configuration 2 where OER catalyst precursors, HER catalyst precursors, or both OER and HER catalyst precursors may be utilized. Different catalyst precursors can be mixed with electrolyte and run through the corresponding side in independent recirculation loops to prevent mixing and each improves performance on its respective side. The improvement in performance is due to in situ synthesis of catalysts and in situ reactive deposition of catalysts on the electrodes and/or separator.

FIG. 5A: Configuration 3 is used to illustrate a process with multiple steps. Many configurations for such processes are possible and they may include different hardware configurations. OER, HER, or both OER and HER catalyst precursors may be added to the electrolyte for in situ synthesis of catalysts for in situ reactive deposition on an anode electrode and/or cathode electrode and/or separator using a Configuration 3 process. FIG. 5A is a diagram of the first step of a Configuration 3 deposition process in which OER catalyst precursors are mixed with electrolyte and circulated through the system with a given applied voltage with the leads set to apply a negative potential to the anode electrode. The leads are shown with a negative potential on the anode electrode, but they can be switched to apply a positive potential on the anode electrode as needed for optimal deposition. With a negative potential on the anode electrode, hydrogen evolution will occur on what is normally the anode electrode during deposition.

FIG. 5B: In the second step of this Configuration 3 deposition, the system is drained and refilled with HER catalyst precursors mixed with electrolyte and circulated through the system at a given current density with the leads set to apply a negative potential to the cathode electrode. The leads are shown with a negative potential on the cathode electrode, but they can be switched to apply a positive potential on what is normally the cathode electrode as needed for optimal deposition.

FIG. 5C: After steps one and two of this Configuration 3 process are completed, the electrodes and/or separator have been coated with the corresponding in situ synthesized catalysts, and clean electrolyte (electrolyte without the addition of catalyst precursors) is pumped into the system which then operates as an electrolyzer with the newly deposited catalysts.

FIG. 6: An electrolyzer system with an integrated apparatus for Configuration 3 in situ synthesis/deposition/regeneration. In any configuration, circulation of catalyst precursors and/or in situ synthesized catalysts in the electrolyte can deposit, repair, or regenerate the catalyst layers by in situ reactive deposition while the electrolyzer stack is running.

FIG. 7: Estimate of stack efficiency over time for in situ stack regeneration using the present invention and a typical alkaline electrolyzer using the stack replacement method. This estimate is based on both stacks operating at the same current density.

FIG. 8: Scanning electron micrograph of a Separator Electrode Assembly (SEA), including an electrically conducting mesh electrode, a separator which prevents product gases from mixing and allows ion transport between anode and cathode, and catalyst coating both the electrode and the separator. Image A shows the flow-facing side of the electrode, while image B shows the separator-facing side of the electrode, where the electrode was peeled away from the separator for imaging.

FIG. 9: Chronopotentiometry data using Ni, Fe, Cr, Cu, and Co-based catalyst precursors with different counterions as described in Example 1. The counter ions used were nitrate (A), sulfate (B), acetate (C), chloride (D), and sulfamate (E). For precursors containing Fe (II) sulfamate, the precursor was mixed with the electrolyte in an inert environment before any current was applied.

FIG. 10A: Scanning electron micrographs of cathodes deposited using Fe (III) sulfate (A), Fe (III) nitrate (B), Ni (II) sulfate and Fe (III) sulfate (C), Ni (II) nitrate and Fe (III) nitrate (D), Ni (II) acetate and Co (II) acetate (E), Ni (II) chloride and Fe (II) chloride (F), Ni (II) sulfamate, Fe (II) sulfamate, and Co (II) sulfamate (G), and Co (II) sulfate and Cr (III) sulfate (H) precursors as described in Example 1. Scale bar is 50 microns.

FIG. 10B: A table of energy dispersive spectroscopy (EDS) results from the catalyst structures shown in FIG. 10A. Values are reported as an atomic ratio of the metals in the system and do not include trace metals or non-metal components such as C, K, or O. Elements detected less than 1% are represented with a dash.

FIG. 11: Chronopotentiometry data using Co (II), Cu (II), and Fe (III) nitrate catalyst precursors (A) and Cr (III) and Ni (II) nitrate catalyst precursors (B).

FIG. 12: Scanning electron micrographs of a cathode deposited using Co (II) nitrate precursor (A), anode deposited with Co (II) nitrate precursor (B), and cathode deposited with Cu (II) nitrate precursor (C). Also shown are scanning electron micrographs of cathodes with no detectable metal deposition using Ni (II) nitrate (D) and Cr (III) nitrate (E) precursors. The irregular pattern on the electrode in (D) is attributed potassium hydroxide from the electrolyte that remained on the electrode surface. Also shown is a bare Ni mesh cathode with no catalyst (F). Scale bar is 50 microns.

FIG. 13: Chronopotentiometry data using various combinations of Fe (III) nitrate, Ni (II) nitrate, Co (II) nitrate, and Cr (III) nitrate catalyst precursors as described in Example 3.

FIG. 14: Scanning electron micrographs of cathodes deposited using mixed metal nitrate precursor blends of Ni and Fe (A), Ni and Co (B), Fe and Cr (C), Co and Cr (D), and Ni and Cr (E). Scale bar is 20 microns.

FIG. 15: A table of energy dispersive spectroscopy (EDS) results on cathodes deposited using each precursor listed. Values are reported as an atomic ratio of the metals in the system and do not include trace metals or non-metal components such as C, K, or O. Elements detected less than 1% are represented with a dash.

FIG. 16: Chronopotentiometry data of mixed metal nitrate catalyst precursors that deposit on the anode or very little on the anode. Plot A displays one blend that deposits primarily on the cathode (Ni, Fe, Cr, and Cu nitrates) and one that deposits on both anode and cathode (Ni, Fe, Co, Cr, and Cu nitrates). Plot B displays a blend that deposits primarily on the cathode (Ni and Fe nitrate) and one that deposits on both anode and cathode (Fe and Co nitrate). Plot C shows a cell that was deposited using Ni, Fe, Co, Cr, and Cu nitrates, then the coated electrodes were paired with new counter electrodes and run in clean KOH. Plot D shows a cell that was deposited using Fe and Co nitrate precursors in a first step, then leads were switched, and Fe and Co nitrate precursors were used to deposit onto the electrodes with reversed potential in a second step. See Example 4 for experiment descriptions.

FIG. 17: Scanning electron micrograph images of an anode (A) and cathode (B) from a cell deposited using Ni, Fe, Cr, and Cu nitrate precursors, an anode (C) and cathode (D) from a cell deposited using Ni, Fe, Co, Cr, and Cu nitrate precursors, and an anode (E) and cathode (F) from a cell deposited using Fe and Co nitrate precursors. Scale bar is 50 microns.

FIG. 18: Scanning electron micrographs of electrodes after the two-step deposition process described in Example 4 with FeCo nitrate. The anode after step 2 is shown in (A) and (C), and the cathode after step 2 is shown in (B) and (D).

FIG. 19: A table of energy dispersive spectroscopy (EDS) results on electrodes deposited using each precursor listed. Values are reported as an atomic ratio of metals in the system and do not include trace metals or non-metal components such as C, K, or O. Elements less than 1% are represented with a dash.

FIG. 20: Chronopotentiometry data using Ni, Fe, and Cr nitrates as catalyst precursors, varying the amount of Cr nitrate (A) and using Ni, Fe, Co, Cr, and Cu nitrates as catalyst precursors, varying the amount of Co nitrate (B).

FIG. 21: Chronopotentiometry data using precursors from 3 metal species (A), 4 metal species (B), 5 metal species (C), and 0-5 metal species (D).

FIG. 22: Scanning electron micrographs after deposition using Ni, Fe, and Co nitrate precursors of the cathode (A) and anode (B).

FIG. 23: Chronopotentiometry data for deposition using Ni, Fe, Co, Cr, and Cu nitrate catalyst precursors at 30° C., 60° C., and 80° C. (A). After 24 h deposition at 30° C. and 60° C., the test cells were heated to 80° C. and run for 6 hours (B).

FIG. 24: Chronopotentiometry data for deposition using Ni, Fe, Co, Cr, and Cu nitrate precursors at 0.3 A cm⁻², 1 A cm⁻², and 2 A cm⁻² (A). After 24 h, the electrolyte for each cell was replaced with clean 30 wt % KOH without added precursors and the cells were run at 1 A cm⁻² to compare performance (B). Plot C shows baseline data for operation at 0.3 A cm⁻², 1 A cm⁻², and 2 A cm⁻² with bare Ni electrodes with no catalyst.

FIG. 25: Chronopotentiometry data for deposition using Ni, Fe, Co, Cr, and Cu nitrate precursors. After 24 h deposition at 1 A cm⁻², the electrolyte solution was replaced with clean 30 wt % KOH without added precursors and the cell was run at 1 A cm-2 for 4.5 hours, then 2 A cm-2 for 22.5 hours, at which point Ni, Fe, Co, Cr, and Cu nitrate precursor mixture was added again to the electrolyte.

FIG. 26: Chronopotentiometry data for deposition using Ni, Fe, Co, Cr, and Cu nitrate precursors in a cell operating at 65° C. with 20 wt % NaOH as the electrolyte.

FIG. 27: Chronopotentiometry data for three different ratios of Ni, Fe, Co, Cr, and Cu nitrates as catalyst precursors. A ratio of 10% Ni, 20% Fe, 10% Co, 30% Cr, and 30% Cu nitrates is represented by a solid black line. A ratio of 10% Ni, 40% Fe, 10% Co, 20% Cr, and 20% Cu nitrates is represented by a dashed line. A mixture with equal percentages of each metal cation is represented by a dotted line.

FIG. 28: An illustration of an alkaline electrolyzer cell used in the Examples.

### DETAILED DESCRIPTION OF THE INVENTION

Disclosed herein are methods, systems, and compositions for synthesizing electrocatalysts inside of an electrolyzer stack (in situ electrocatalyst synthesis) and for reactively depositing electrocatalysts on the electrodes inside of an electrolyzer stack (in situ reactive deposition). Both in situ synthesis and in situ reactive deposition can occur while the electrolyzer stack is running and producing hydrogen and/or oxygen. In situ synthesis can occur in the electrolyte inside an electrolyzer while it is not running. The same methods, systems and compositions also make it possible to regenerate or repair catalysts inside of a fully assembled stack, making it possible to service an electrolyzer stack and recover from loss in performance without needing to shut down, disassemble, or reassemble the electrolyzer or the stack.

One aspect of the invention provides for the addition of electrocatalyst precursors to an electrolyte comprising OH− or H+ to synthesize a hydrogen evolution electrocatalyst, an oxygen evolution electrocatalyst, a bifunctional hydrogen/oxygen evolution electrocatalyst, or any combination thereof in situ. Electrocatalyst precursors may include non-catalytic homogeneous solutions of metal ions such as Ni, Fe, Co, Cr, Cu or other transitions metals with counter ions such as nitrates, nitrites, sulfates, sulfamates, chlorides, bromides, iodides, perchlorates, cyanides, thiocyanates, acetates, ammonium, sodium, or other counter ions.

Another aspect of the technology provides for using in situ electrocatalyst synthesis and in situ reactive deposition to form mixed metal electrocatalysts on the electrodes inside of an electrolyzer stack by combining metals that enable in situ deposition (enabling metals) with other metals that improve catalyst performance but do not deposit by themselves. Enabling metals may include Fe, Co, and Cu. Metals that may improve catalyst performance but may not readily deposit by themselves may include Ni and Cr.

The methods described herein allow for the deposition of electrocatalysts onto the electrodes in an alkaline electrolyzer. The present technology can significantly lower stack fabrication costs, allow for field regeneration of electrolyzer stacks, and improve stack efficiency. It has the potential to significantly lower the overall capital costs of the electrolyzer and allow for regular catalyst regeneration to ensure stack efficiency remains high over the entire lifetime of the system. In situ electrocatalyst synthesis, in situ reactive deposition/regeneration, and operation with deposited catalysts can occur independently or simultaneously. Simultaneous operation allows for self-healing of catalysts during operation.

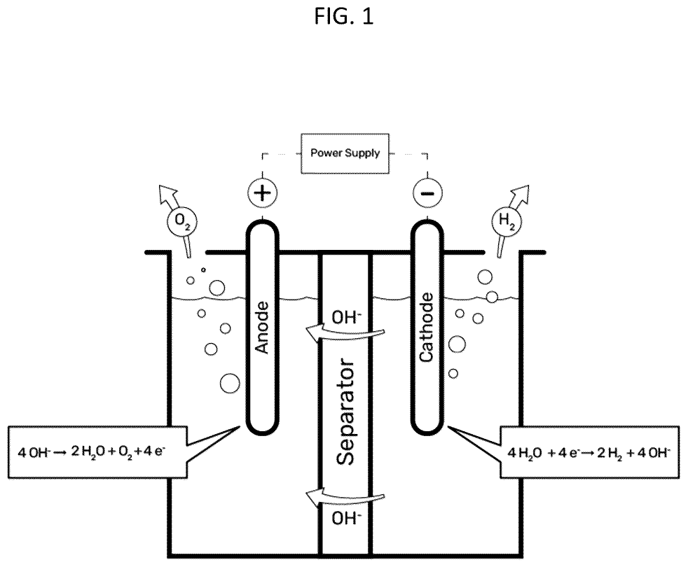

An alkaline electrolyzer is a system for the conversion of water into molecular oxygen and hydrogen. The operation of a typical alkaline electrolyzer is shown in FIG. 1. The HER occurs on the cathode (i.e., negatively charged electrode in an electrolyzer). There, water is split to generate hydrogen as described by the half-reaction:

4H₂O+4e⁻→2H₂+4OH⁻ (eqn 1).

The OER occurs on the anode (i.e., positively charged electrode in an electrolyzer). There, hydroxide ions are converted into oxygen as described by the half-reaction:

OH⁻→2H₂O+O₂+4e⁻ (eqn 2).

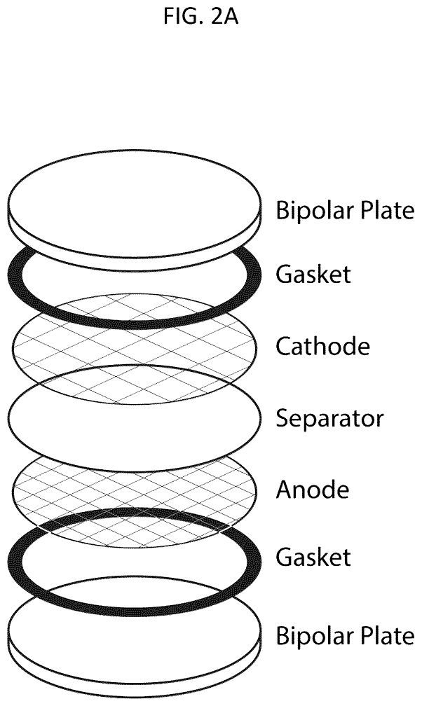

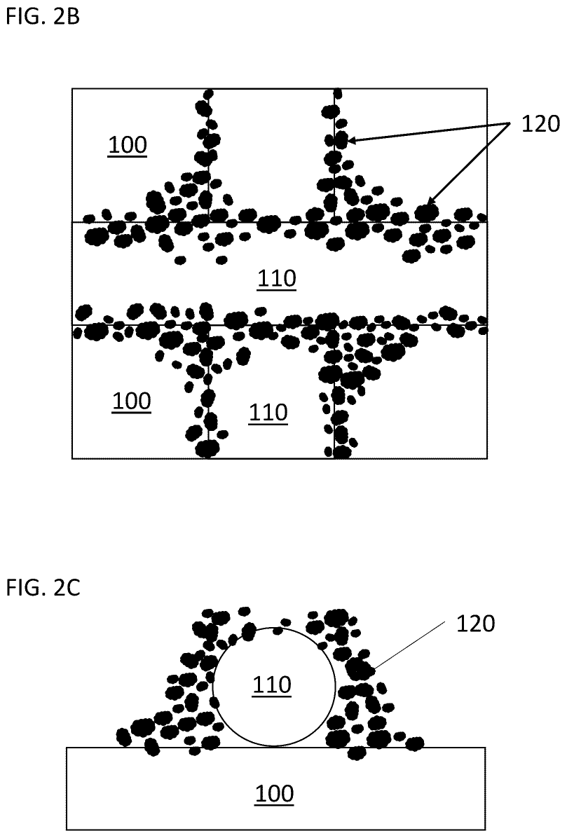

One or both of the electrodes are typically coated with electrocatalysts prior to assembly of the stack, which consists of repeating cells each comprised of a cathode and anode with a separator in between (FIG. 2A). Once integrated with the balance of plant for operation, the stack is typically non-serviceable and must eventually be replaced due to a decrease in efficiency over time. The electrocatalyst coated on the electrodes may be selected from a variety of OER, HER, and/or bifunctional OER-HER catalysts. Examples are provided in US 2023/0013895.

In some embodiments of the present invention catalyst precursors are used to form an OER electrocatalyst comprised of Ni, Fe, Co, Cr, Cu or any combination thereof. In some embodiments, the electrocatalyst precursor is comprised of 1, 2, 3, 4, 5, or more than 5 of any of the foregoing. In some embodiments, the electrocatalyst precursor is composed of 2, 3, 4, or more than 4 different metals.

In some embodiments of the present invention catalyst precursors are used to form an HER electrocatalyst comprised of Ni, Fe, Co, Cr, Cu or any combination thereof. In some embodiments, the electrocatalyst precursor is comprised of 1, 2, 3, 4, 5, or more than 5 of any of the foregoing. In some embodiments, the electrocatalyst precursor is composed of 2, 3, 4, or more than 4 different metals.

In some embodiments of the present invention catalyst precursors are used to form a bifunctional hydrogen/oxygen evolution electrocatalyst comprised of Ni, Fe, Co, Cr, Cu or any combination thereof. In some embodiments, the electrocatalyst precursor is comprised of 1, 2, 3, 4, 5, or more than 5 of any of the foregoing. In some embodiments, the electrocatalyst precursor is composed of 2, 3, 4, or more than 4 different metals.

Some of the electrocatalysts prepared by the disclosed methods are suitable for HER or OER and some have bifunctional activity making them suitable for both HER and OER. Bifunctional HER-OER catalysts are mainly first-row transition metal-based compounds. In some embodiments, the bifunctional HER-OER catalysts comprise Co, Ni, Fe, Cr, Cu, or any combination thereof.

In other embodiments in situ synthesis and in situ reactive deposition to form mixed metal electrocatalysts on the electrodes inside of an electrolyzer stack is achieved by combining metals that enable in situ deposition of mixed metal catalysts (enabling metals) with other metals that improve catalyst performance but do not deposit by themselves. Enabling metals include Fe, Co, and Cu. Metals that improve catalyst performance but do not readily deposit by themselves using these methods include Ni and Cr. The resulting mixed metal catalysts lower the voltage required for the HER, the OER or both the HER and the OER. Both in situ synthesis and in situ reactive deposition can occur while the electrolyzer stack is running and producing hydrogen.

The catalyst precursors and electrocatalysts used in the electrolyzers, reactors, and methods disclosed herein are provided in an alkaline electrolyte. Alkaline electrolytes may include a source of OH⁻, which may include KOH, NaOH, or LiOH. Alkaline electrolyzers tend to operate in the range of approximately 20-45 wt % KOH, NaOH, or LiOH aqueous electrolyte. In some embodiments, the alkaline electrolyte is comprised of 25-32 wt % KOH, NaOH, or LiOH aqueous electrolyte. Suitably, the alkaline electrolyte may comprise about 30 wt % KOH. However, acidic to neutral electrolytes with catalyst precursors can also be used to preferentially deposit on the anode, for example, prior to normal operation with alkaline electrolyte.

The electrolytes described herein may comprise an effective amount of one or more electrocatalyst precursor. An effective amount of electrocatalyst precursor is an amount of electrocatalyst precursor to achieve a desired effect. In some embodiments, the desired effect is to synthesize and deposit an electrocatalyst to decrease the voltage required for a hydrogen evolution reaction or an oxygen evolution reaction for a given current density. In some embodiments, the desired effect may be for deposition of an electrocatalyst onto an electrode and/or a separator. In some embodiments, the desired effect may be a combination of different desired effects. The effective amount of the electrocatalyst precursor may depend on a number of different factors, including, without limitation, the composition of the electrocatalyst precursor, the composition of the electrolyte, the operational configuration of the electrolyzer, or the operational configuration of a reactor system. In some cases, the electrocatalyst may deposit on only the cathode or the electrocatalyst may deposit on both the cathode and the anode.

In some embodiments, an effective amount of electrocatalyst precursor(s) may be about 0.00000001-10.0 mol/cm², where moles are based on the electrocatalyst precursor metal(s) in the electrocatalyst precursor(s) and the area is based on the total surface area of electrode(s), which may include cathode(s) and/or anode(s), but different amounts of the electrocatalyst precursor may also be used, depending on electrode surface area and desired loading. Suitably, the effective amount may be from about 0.00000001-0.0000001 mol/cm², 0.0000001-0.000001 mol/cm², 0.000001-0.00001 mol/cm², 0.00001-0.0001 mol/cm², 0.0001-0.001 mol/cm², 0.001-0.01 mol/cm², 0.01-0.1 mol/cm², 0.1-1.0 mol/cm², or 1.0-10.0 mol/cm². To reach the desired loading of in situ synthesized and reactively deposited electrocatalysts, the effective amount of electrocatalyst precursor(s) may be added to the electrolyte all at once or in small increments. In embodiments where the electrocatalyst precursor(s) is added in multiple increments, each increment may be allowed to deposit before adding the next increment. Further, different catalyst precursors can be added sequentially to create desired catalyst structures and compositions.

Cell elements, such as flow fields, may also be coated with catalyst which may require additional amounts of electrocatalyst precursors. The relative amount of each metal ion in the one or more electrocatalyst precursors can be tuned to improve deposition amount, deposition on either the cathode or anode or deposition onto both cathode and anode, and to improve catalytic performance as measured by drop in voltage of the water splitting reactions.

The electrolyte includes a source of OH⁻ and optionally an electrocatalyst precursor. In some instances, the electrolyte may be a solution of dissolved ions or the electrolyte may be a suspension comprising electrocatalyst particles synthesized in situ. In some embodiments, the effective particle size of electrocatalyst synthesized in situ and suspended in the electrolyte may be from about 1 nm to about 10 microns, including any value in between. The effective particle size may be determined by those skilled in the art and may, for example, refer to a mean, mode, median, or distribution of sizes depending on context.

Electrocatalysts synthesized in aqueous electrolytes are uniquely compatible with in situ deposition and utilization in electrolyzers that operate with aqueous electrolyte.

Electrolytes may be prepared as follows. Electrocatalyst precursors, including metal salts, may be prepared as an aqueous solution of metal ions and counter ions. Modifications to the solution to improve metal ion and counter ion solubility may be used, including changing temperature, pressure, reducing metal salt particle size, addition of hydrotropes (e.g., urea, tosylate from toluene sulfonic acid salts, cumenesulfonate from cumene sulfonic acid salts, or xylenesulfonate from xylene sulfonic acid salts), changing pH, or introducing non-aqueous solvents and/or surfactants.

The concentration of the metal ions in the aqueous solution is typically in the range of 0.0000001-10 M but the exact concentration of the aqueous solution is not critical to the invention. Depending on the metal precursor compound(s) (e.g., metal salts with counter ions such as nitrates, nitrites, sulfates, sulfamates, chlorides, bromides, iodides, perchlorates, cyanides, thiocyanates, acetates, ammonium, sodium, or other ions) used in the method, other byproducts may also be present in the aqueous suspension. The vol % described in the Examples has been achieved with aqueous metal salt solutions of approximately 0.2 M metal ion concentration. This solution is mixed with aqueous electrolyte, such as 30 wt % KOH, to produce the reported vol %. For example, for 2.0% v/v Fe (III) nitrate in aqueous 30 wt % KOH (as reported in Example 1), Inventors mixed 0.816 mL of 0.2 M aqueous Fe (III) nitrate solution with 40 mL of aqueous electrolyte containing 30 wt % KOH. This electrolyte mixture was then used to deposit on a 0.2 cm² cathode, resulting in a precursor to electrode area ratio of 0.000816 mol/cm². In this ratio, the surface area is only based on the cathode because the Fe only deposited on the cathode. Other precursors could be mixed in varying concentrations in water or other solutions, or the precursors could be added directly to the aqueous electrolyte. Various mixtures of metal precursors with liquids or gases fall within the scope of the invention so long as they can be recirculated through the electrolyzer stack while electric current is applied. This can be achieved with a wide range of water-soluble precursors and/or liquid solutions of precursors, typically prepared at room temperature and atmospheric pressure. In some instances, the water-soluble precursors may include Fe (III) nitrate, Ni (II) nitrate, Co (II) nitrate, Cr (III) nitrate, Cu (II) nitrate, Fe (II) chloride, Ni (II) chloride, Co (II) chloride, Ni (II) acetate, Co (II) acetate, Ni (II) sulfamate, Fe (II) sulfamate, Co (II) sulfamate, Ni (II) sulfate, Fe (III) sulfate, Cu (II) sulfate, Co (II) sulfate, or Cr (III) sulfate, or any combinations thereof.

Without wishing to be bound by theory, the disclosed methods for synthesizing, depositing electrocatalytic materials may be accomplished by reactive adsorption (alternatively, ‘reactive deposition’) of the catalyst precursors and electrocatalysts onto the electrodes and separator. In reactive deposition a driving force-beyond electrostatic forces alone-exists and causes a reaction of the catalyst precursor to occur when deposited on the substrate. In reactive deposition, the catalyst may be generated on the surface of the electrode and may deposit at higher loadings than in strong electrostatic adsorption. Further, reactive adsorption may occur on surfaces having the same charge. For example, negatively charged catalyst may deposit on negatively charged cathode or, alternatively, positively charged catalyst may deposit on positively charged anode. Reactive adsorption may also include long deposition times (e.g., greater than 60 minutes to approaching 100 hours) in comparison to electrostatic driven adsorption. In electrostatic driven adsorption once the first layer is formed on the charged deposition substrate, the surface charge interaction may be lost and deposition may slow or stop. Finally, reactive adsorption may produce complex three-dimensional fractal structures. Reactive adsorption may occur through precipitation reactions, analogous to crystal growth, and may enable complex geometries. These complex geometries provide surprisingly efficient catalytic structures.

Reactive deposition is unique from other deposition mechanisms, such as strong electrostatic adsorption and electroplating. As established in the art, oxides have a point of zero charge (PZC), which is defined as the pH where the surface of the oxide is neutrally charged. At pH values more acidic than the PZC, the surface of the oxide becomes positively charged, and at pH values more basic than the PZC, the surface of the oxide becomes negatively charged. In classic strong electrostatic adsorption, when the electrode surface is positively charged, negatively charged particles may bind to the surface. Similarly, when the electrode surface is negatively charged, positively charged particles may bind to the surface. With strong electrostatic adsorption, a thin, flat monolayer coverage of the catalyst is expected. Further, because the catalyst deposits in thin layers, deposition is fast (e.g., 5-60 minutes). Finally, because the surface charge of the electrode holds the catalyst to the surface, once the potential is removed, the catalyst particles would no longer adhere to the surface strongly.

Electroplating is a process for producing a metal coating on a solid substrate through the reduction of cations of that metal by means of a direct electric current. The part to be coated acts as the cathode (negative electrode) of an electrolytic cell; the electrolyte is a solution of a dissolved salt of the metal to be coated; and the anode (positive electrode) is typically either a block of that metal, or of some inert conductive material. Conditions for electroplating are typically chosen to minimize hydrogen evolution and provide thin, uniform coatings. In contrast, the in situ reactive deposition of the present invention creates high surface area, high edge site density structures, which maximize both catalytic performance and mass transfer during water electrolysis. Further, in situ synthesis of the present invention may create particles in the electrolyte that undergo the in situ reactive deposition during typical electrolyzer operating conditions. In situ reactive deposition can also create coatings on both the anode and cathode simultaneously, which further distinguishes this process from typical electroplating.

Disclosed herein are methods for synthesizing, depositing and utilizing electrocatalytic materials in situ in an electrolyzer stack or in a reactor. These methods may be used while electrochemical reactions are occurring. The presently disclosed technology allows for synthesis and deposition of catalysts inside of an electrolyzer stack without the need to open or disassemble the stack.

In some embodiments, one or both of the electrodes in an electrolyzer are in contact, in direct contact, or close proximity with the separator, thereby making it possible to form a separator electrode assembly (SEA). A separator is a permeable or semipermeable material positioned between the anode and cathode and serves to keep the electrodes separated, prevent electrical short circuits, prevent mixing of product gases, and allow the transport of ionic charge carriers between the electrodes. Separators may comprise a polymer material that should be chemically and electrochemically stable with regard to the electrolyte and its ionic charge carriers as well as the electrode materials under typical operating conditions.

Separators suitable for use with the present technology include those for use under alkaline water electrolysis conditions. Separators may comprise an open mesh and may optionally be symmetrically or asymmetrically coated with one or more polymers or inorganic oxides. Exemplary separators include those composed of an open mesh of polyphenylene sulfide fabric symmetrically coated with a mixture of polymer and zirconium oxide, such as the Zirfon UTP 500+ and Zirfon UTP 220 separators used in the Examples. Other separators suitable for use with the presently disclosed technology include plain asbestos, polymer-reinforced asbestos, polytetrafluoroethylene-bonded potassium titanate, polymer-bonded zirconia, polyphenylene sulfide, Fortron®, Torcon™, Ryton®, polybenzimidazole-based polymer electrolyte membranes, anion exchange membranes, Fumasep FAA-3, Aemion+™, and Sustainion® X37.

To allow electrolyte and/or ions to permeate the separator, an electrode contacting or in close proximity to the separator may have openings therethrough. The openings through the electrode or proximity of the electrode to the separator define areas on the surface of the separator that are electrolyte exposed. In some embodiments, the electrode is a mesh composed of a plurality of intersecting conductive wires. The plurality of intersecting conductive wires may be woven, knitted, or sintered into square, rectangular, rhombic, triangular, hexagonal, twill, or other pattern. In other embodiments, the plurality of intersecting conductive wires have no pattern at all. Other exemplary electrodes include, without limitation, a foam formed from a plurality of pores in a conductive material, a perforated or slotted conductive plate, or an expanded conductive metal.

FIGS. 2B and 2C illustrate a SEA after in situ electrocatalyst synthesis and deposition. The SEA comprises an electrode 110 comprising conductive wires intersecting at a right angle in contact with a separator 100. The openings through the electrode 110 allows for electrolyte to pass through and defines areas on the surface of the separator 100 that are electrolyte-exposed. During in situ deposition of electrocatalyst, electrocatalyst 120 may be deposited on both the electrode 110 and separator 100. This allows for the electrocatalyst 120 to be in direct contact with the separator 100.

During in situ deposition, catalyst coats the electrode, forming a bridge between the electrode and the separator, and extends out onto the separator as shown in the SEM image in FIG. 8. The SEM image shows that catalyst is coating the mesh as well as the separator. The SEA provides intimate connection between the electrical conductor, catalyst, and separator. This type of structure can only be formed when catalyst is deposited with both the electrode and separator present. It cannot be formed if an electrode is coated by itself with a catalyst.

As demonstrated by the Examples, deposition on the electrode and separator improves system performance. The electrons needed to drive the reactions are provided by the electrode, which is in intimate contact with the catalyst, thus providing efficient electron transfer. The catalyst is also in intimate contact with the separator, so it is positioned to efficiently send and receive OH− ions through the separator as they are generated/consumed during the electrochemical reactions.

Hydrogen evolution electrocatalysts, oxygen evolution electrocatalysts, bifunctional hydrogen/oxygen evolution electrocatalysts, or any combination thereof synthesized in situ from metal precursors may be deposited in situ on electrodes, flow fields, separators, or any combination thereof.

The electrolytes described herein may be utilized under various pH, temperatures, concentrations, voltages or current densities. The voltage or current density may be selected to allow for a gas evolution reaction, electrocatalyst synthesis, and/or reactive deposition of the electrocatalyst.

For example, single cell voltages in the range of 1.23-5 V with current densities of 0.001-5 A cm⁻² may be used. In some instances, current densities of 0.3 to 2.0 A cm⁻² may be used. In electrolyzers, the HER and OER may occur simultaneously under these conditions.

The temperature of electrolytes during deposition may be 15-135° C. In other cases, the temperature may be 30 to 80° C.

As demonstrated in the Examples, deposition was achieved under constant current operation at 0.3 A cm⁻². Some in situ synthesized catalysts require a voltage of around 1.75 V to achieve deposition at 0.3 A cm⁻². The cathode electrode may be biased at a potential of −1.75 V with respect to the anode electrode while the anode electrode may be biased at a potential of +1.75 V with respect to the cathode electrode. With the leads switched, the cathode electrode may be biased at a potential of +1.75 V with respect to the anode electrode and the anode electrode may be biased at a potential of −1.75 V with respect to the cathode electrode. The signs of the potentials for the cathode and anode are always opposite, with positive potentials producing anodic (oxidizing) current and negative potentials producing cathodic (reducing) current.

With the presently disclosed in situ method simultaneous catalyst synthesis, deposition and HER/OER may be achieved.

In one embodiment, the catalyst can be deposited onto the electrodes, flow fields, separators, or any combination thereof in situ in an electrolyzer or in a reactor used for deposition.

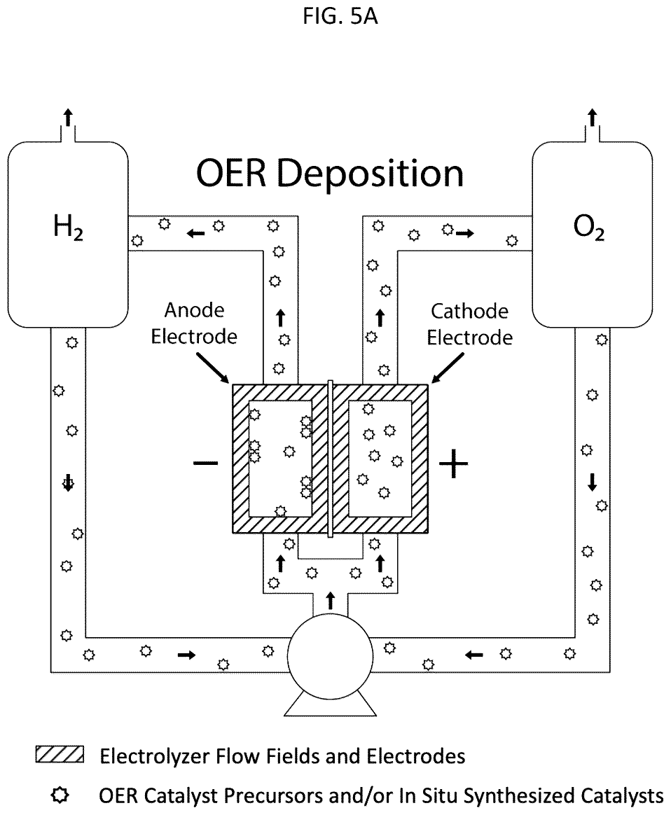

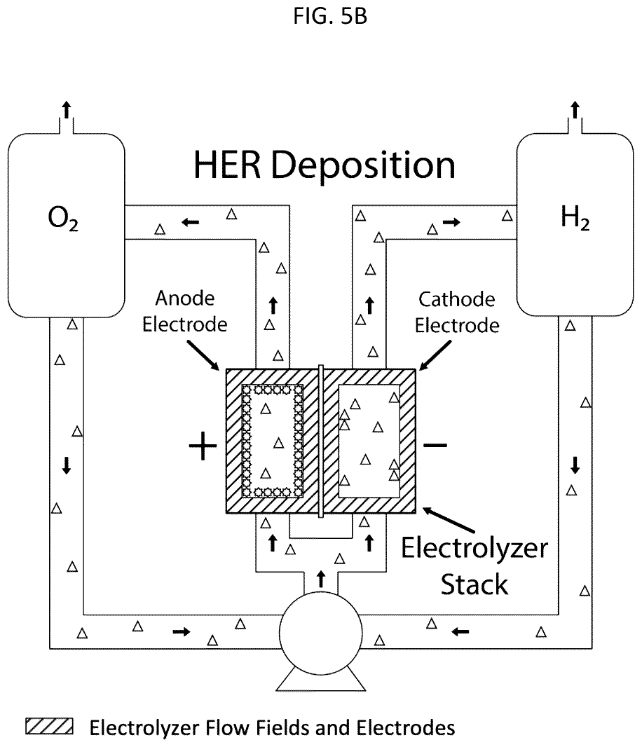

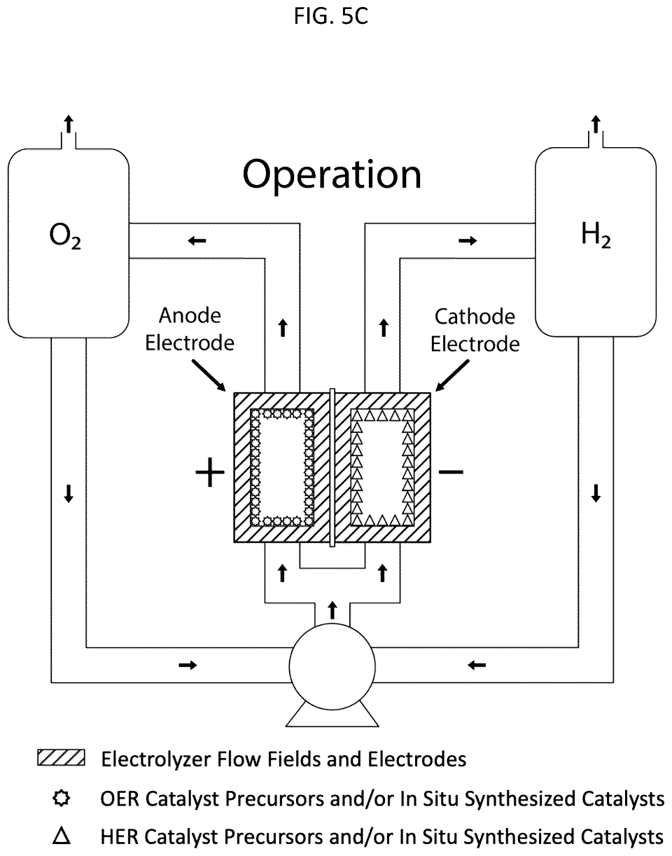

Deposition can occur under either negative or positive potentials and it is possible to deposit catalysts under either potential by changing the polarity for a given deposition step. For example, if the most favorable deposition for an OER catalyst occurs under negative potentials, OER catalyst precursors can be added to the electrolyte while the electrolyzer or reactor is run with a negative potential applied to the anode electrode as shown in FIG. 5A. This causes the anode electrode to experience negative potentials.

Next, the electrolyzer stack or reactor can be drained and refilled with electrolyte mixed with HER catalyst precursors. If the most favorable deposition for the HER catalyst occurs under negative potentials, a negative potential can be applied to the cathode electrode as shown in FIG. 5B. Finally, the electrolyte with suspended HER precursors and catalysts can be replaced with clean electrolyte (electrolyte without the addition of catalyst precursors) and the electrolyzer can be operated as shown in FIG. 5C, now with the anode and cathode coated with OER and HER catalysts, respectively.

Some catalysts synthesized in situ from metal precursors may deposit under both negative and positive potentials.

Similarly, deposition can occur under either acidic, neutral, or alkaline pH and it is possible to deposit catalysts under different pHs by changing the electrolyte for a given deposition step. For example, if the most favorable deposition for an OER catalyst occurs under acidic pH, the electrolyzer or reactor can be run with acidic electrolyte containing catalyst precursors and operated as usual. This causes reactive deposition onto the anode electrode without switching the leads.

Next, the electrolyzer stack or reactor can be drained and refilled with alkaline electrolyte containing HER catalyst precursor. If the most favorable deposition for the HER catalyst occurs under negative potentials, a negative potential can be applied to the cathode electrode. Finally, the electrolyte with suspended in situ synthesized HER catalyst can be replaced with clean electrolyte (electrolyte without the addition of catalyst precursor) and the electrolyzer can be operated as usual for hydrogen production, now with the anode and cathode coated with OER and HER catalysts, respectively.

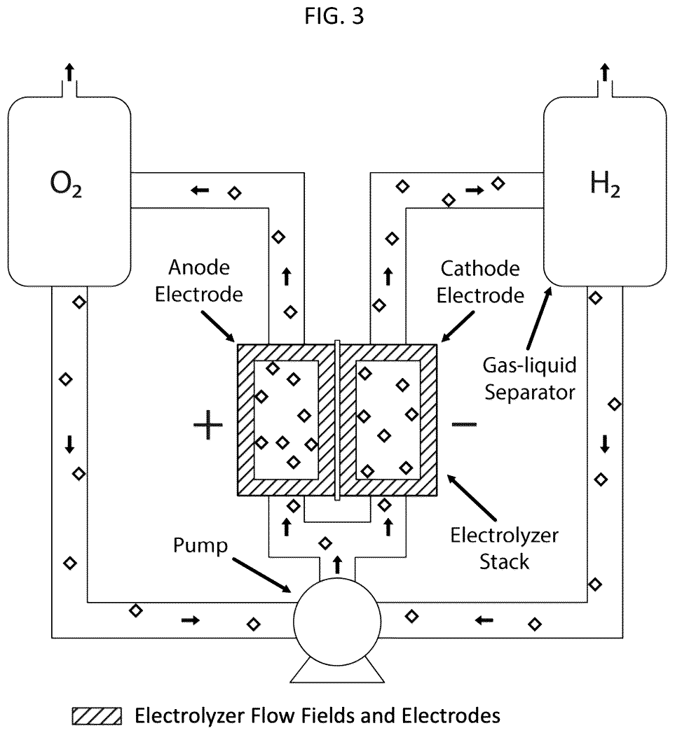

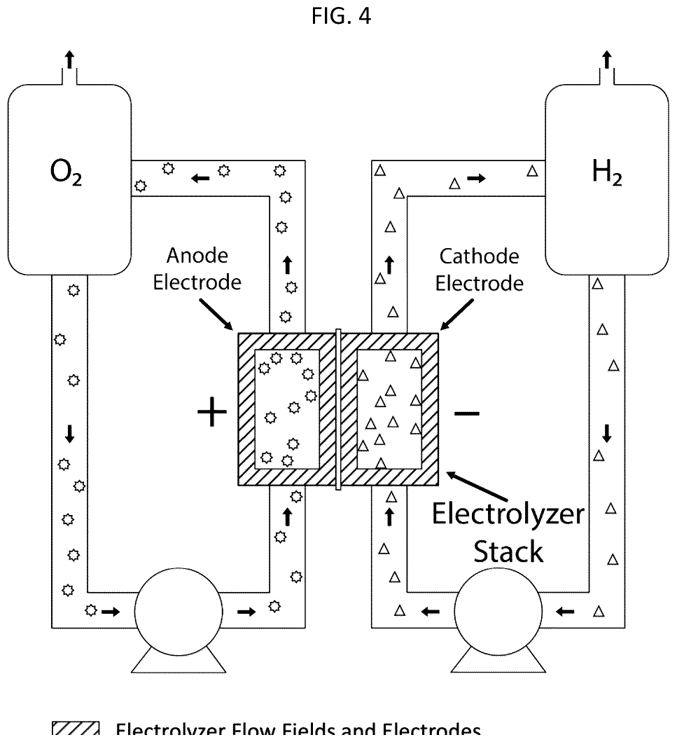

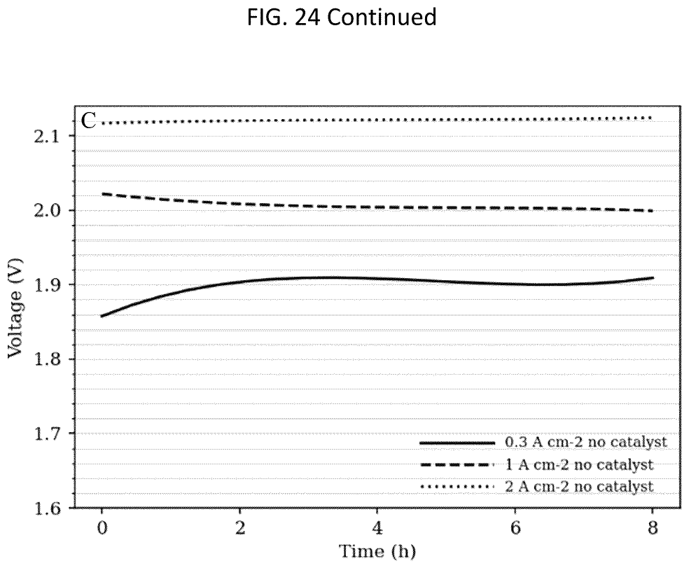

In still another embodiment, performance can be improved by mixing catalyst precursors with electrolyte and reactively depositing catalysts in situ onto the electrodes, flow fields, separators or any combination thereof in an electrolyzer stack or reactor in a single step on both the anode and cathode of the electrolyzer stack as shown in FIG. 3. After the deposition step, the electrolyte with catalyst precursors can be replaced with clean electrolyte and the electrolyzer is operated normally. The Examples demonstrate sustained improvement under such operation after deposition using a mixture of Ni, Fe, Co, Cr, and Cu precursors. Stable performance has been recorded at current densities ranging from 0.3 A cm⁻² to 2 A cm⁻² (FIG. 24).

In still another embodiment, performance can be improved by mixing catalyst precursors with electrolyte and reactively depositing catalysts in situ onto the electrodes, flow fields, separators or any combination thereof in an electrolyzer stack or reactor in a single step on both the anode and cathode of the electrolyzer stack as shown in FIG. 3, and the electrolyzer is operated normally without replacing the electrolyte with clean electrolyte. This configuration allows for self-healing operation where in situ reactive deposition and operation with deposited electrodes are simultaneously occurring.

The methods described can be performed with the electrolyzer stack fully assembled, which gives rise to the possibility of periodic regeneration in the field to avoid decreases in stack efficiency due to catalyst degradation.

As illustrated in FIGS. 5A-5C, the electrolyte could be drained and flushed with clean electrolyte, if necessary, before or after performing the OER and/or HER synthesis and deposition steps. Caution must be taken to avoid explosive mixtures of hydrogen and oxygen during any deposition steps where the anode electrode sees a negative potential because this will cause hydrogen to be produced on the normally oxygen-producing side and oxygen to be produced on the normally hydrogen-producing side.

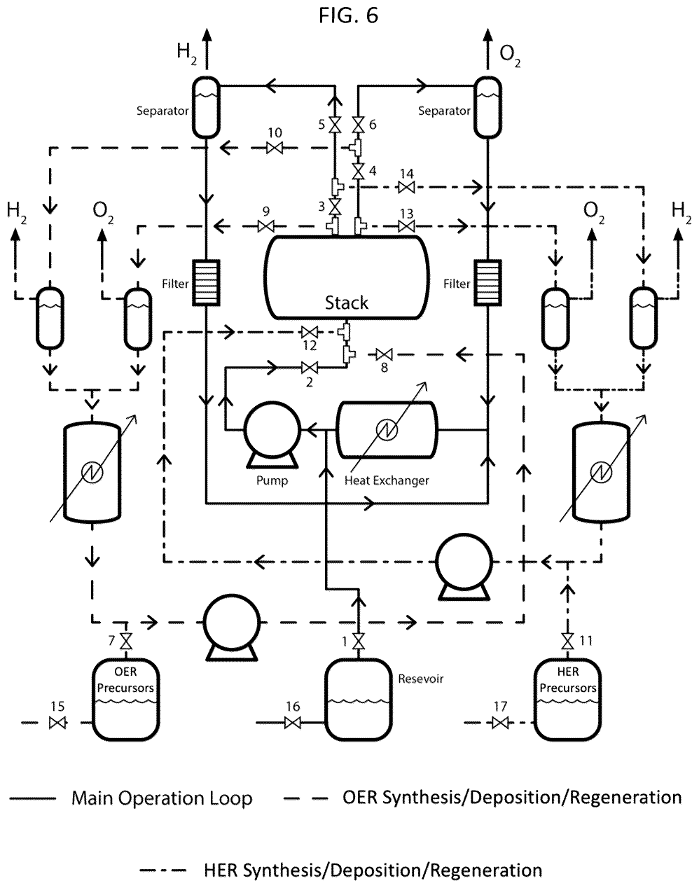

As illustrated in FIG. 6 an apparatus for periodic regeneration in the field could allow for deposition steps to occur in isolation from the main electrolyzer balance of plant to prevent buildup of catalysts and intermixing of hydrogen and oxygen in the system. In addition, a soak with acidic or basic solution (e.g., 1-50 wt %) can be employed if the previous coating needs to be cleaned or removed before regeneration.

FIG. 6 shows an exemplary electrolyzer system integrated with an apparatus for field regeneration. FIG. 6 illustrates a main recirculation loop (solid lined) for operation of the electrolyzer system that includes the electrolyzer stack, pump, filters, gas-liquid separators, and heat exchanger. Two independent recirculation loops are also included for the OER (dash-dash line) and HER (dash-dot line) catalyst precursor insertion and deposition steps. The deposition or regeneration loops may include all of the same components as the main loop, or they may exclude the filters which could interfere with the catalyst synthesis or deposition process. The two independent recirculation loops may include different sized components than the main recirculation loop. They may also have different component arrangements. A series of valves across the whole system allow it to be operated in three different modes: electrolysis operation (solid line, FIG. 6), OER synthesis/deposition/regeneration (dash-dash line, FIG. 6), and HER synthesis/deposition/regeneration (dash-dot line, FIG. 6). Electrolysis operation requires valves 1, 7, 8, 9, 10, 11, 12, 13, 14, 15, 16, and 17 to be closed, and the rest of the valves to be open. This allows the electrolyte to flow only through the main system. When transitioning to a regeneration procedure, the electrolyte may be drained into the reservoir by opening valve 1. The clean electrolyte reservoir may be drained and refilled with fresh clean electrolyte (electrolyte without the addition of catalyst precursors) as necessary using valve 16.

Valves 4, 7, 8, 9, and 10 may be opened and valves 1, 2, 3, 6, 12, 13, 15, 16, and 17 closed so that the OER catalyst precursors in electrolyte can be pumped in from the reservoir without mixing with the main recirculation or HER synthesis/deposition/regeneration loops. Once the system is filled with OER catalyst precursors in electrolyte, valve 7 may be closed and the system can be operated at the relevant current density for the amount of time required to complete synthesis/deposition/regeneration. The leads may be positioned for this process so that the anode electrodes experience either positive or negative potentials. Finally, valve 7 may be opened and the OER catalyst precursors and/or in situ synthesized catalysts in electrolyte drained back into the reservoir. The OER catalyst precursor reservoir may be drained and refilled with fresh OER catalyst precursors in electrolyte using valve 15 as necessary. In some cases, the OER catalyst precursors are suspended in electrolyte. In addition, the OER catalyst precursor reservoir tank may be equipped with a mixer to ensure the catalyst precursors and/or in situ synthesized catalysts are well-suspended in the electrolyte when they are pumped into the system for synthesis/deposition/regeneration.

Valves 3, 11, 12, 13, and 14 may be opened and valves 1, 2, 4, 5, 8, 9, 10, 15, 16, and 17 closed so that the HER catalyst precursors in electrolyte can be pumped in from the reservoir without mixing with the main recirculation or OER synthesis/deposition/regeneration loops. Once the system is filled with HER catalyst precursors in electrolyte, valve 11 may be closed and the system can be operated at the desired current density for the amount of time required to complete synthesis/deposition/regeneration. The leads may be positioned for this process so that the cathode electrodes experience either positive or negative potentials. Finally, valve 11 may be opened and the HER catalyst precursors and/or in situ synthesized catalysts in electrolyte may be drained back into the reservoir. The HER catalyst precursor reservoir may be drained and refilled with fresh HER catalyst precursors in electrolyte using valve 17 as necessary. In addition, the HER catalyst precursor reservoir tank may be equipped with a mixer to ensure the catalyst precursors and/or in situ synthesized catalysts are well-suspended in the electrolyte when they are pumped into the system for synthesis/deposition/regeneration.

In practice, the OER and HER recirculation loops could be fully integrated with the main system, or they could be mounted on a separate skid that could be transported to the main system location for periodic field regeneration with suitable interconnections. Once the procedures for the OER catalyst and HER catalyst synthesis/deposition/regeneration have been completed, clean electrolyte (electrolyte without the addition of catalyst precursors) can be pumped into the system by opening valve 1 and the system can be operated as an electrolyzer as described above until further regeneration is required.

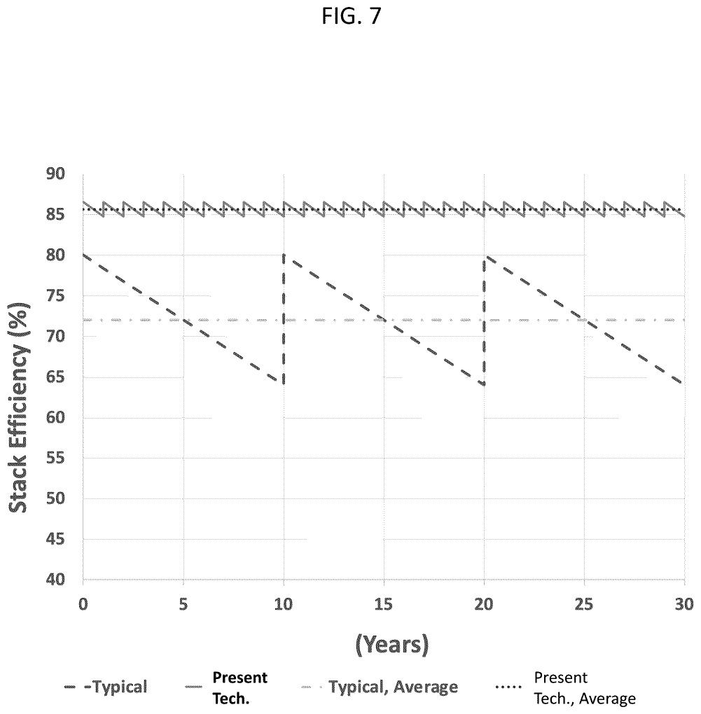

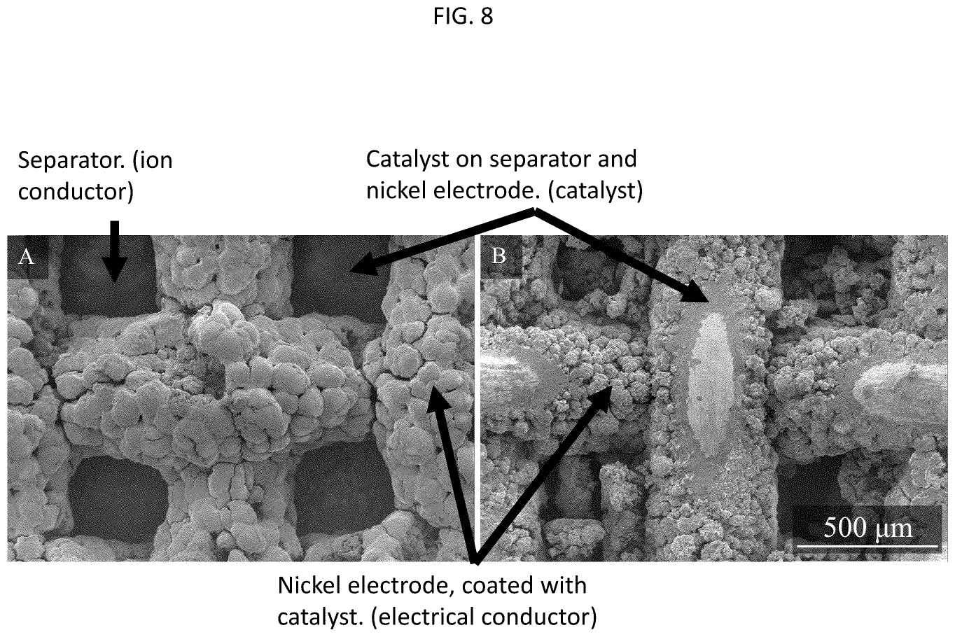

FIG. 7 shows a schematic example of operation data using in situ deposition versus the existing typical stack replacement method. The present technology also allows for frequent catalyst regeneration to maintain high stack efficiency. The stack efficiency of typical electrolyzers will gradually degrade over time until stack replacement is warranted. Due to the high capital cost of stack replacement, a degradation in efficiency of 10-20% over 5 to 10 years is typically tolerated. FIG. 7 shows stack replacement at 10-year intervals and a linear decrease in efficiency during operation. In situ catalyst synthesis and deposition allows for recovery of efficiency losses by frequent regeneration cycles, shown on the top curves of FIG. 7, which can be performed at a low cost.

Operating with in situ synthesized catalysts in the electrolyte can have a self-healing effect with the catalyst in the electrolyte being deposited in situ and replacing catalyst lost due to catalyst delamination/deactivation that may occur over time during operation of the electrolyzer.

The presently disclosed technology is not limited to a particular type of electrolyzer such as an alkaline electrolyzer. Suitably, the present technology may also be applied to electrolyzers such as Alkaline Exchange Membrane (AEM), membraneless, chlor-alkali, hydrochloric acid, urea, nitrogen, ammonia, or CO₂ electrolyzers. In addition, the technology is not limited to a particular type of electrochemical device. Suitably, the present technology may be applied to fuel cells such as alkaline fuel cells, as well as flow batteries or hybrid electrochemical devices.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EMBODIMENTS OF THE INVENTION

Embodiment 1. A method for depositing electrocatalysts, the method comprising:
introducing into an alkaline electrolyzer an electrocatalyst precursor, wherein the alkaline electrolyzer has an electrolyte comprising OH− and one or more electrodes or
mixing an electrocatalyst precursor with an electrolyte comprising OH− and contacting the resulting mixture with one or more electrodes having a current applied thereto.

Embodiment 2. The method of Embodiment 1, wherein a current is applied to the one or more electrodes during introduction of the electrocatalyst precursor.

Embodiment 3. The method of Embodiment 1, wherein a current is applied to the one or more electrodes prior to and during introduction of the electrocatalyst precursor without interrupting application of the current to the one or more electrodes.

Embodiment 4. The method of Embodiment 1 comprising mixing the electrocatalyst precursor with the electrolyte comprising OH− and contacting the resulting mixture with the one or more electrodes having a current applied thereto.

Embodiment 5. The method of Embodiment 4, wherein the electrocatalyst precursor and the electrolyte are mixed in an alkaline electrolyzer comprising the one or more electrodes having the current applied thereto.

Embodiment 6. The method of any one of the preceding Embodiments, wherein the electrocatalyst precursor comprises a metal nitrate, a metal sulfate, a metal acetate, a metal chloride, a metal sulfamate, or any combination thereof.

Embodiment 7. The method of any one of the preceding Embodiments, wherein the electrocatalyst precursor comprises Fe, Ni, Co, Cr, Cu, or any combination thereof.

Embodiment 8. The method of any one of the preceding Embodiments, wherein the electrocatalyst precursor is in solution, optionally aqueous solution.

Embodiment 9. The method of any one of the preceding Embodiments, wherein the electrocatalyst precursor is an aqueous solution of Fe (III) nitrate, Ni (II) nitrate, Co (II) nitrate, Cr (III) nitrate, Cu (II) nitrate, Fe (II) chloride, Ni (II) chloride, Co (II) chloride, Ni (II) acetate, Co (II) acetate, Ni (II) sulfamate, Fe (II) sulfamate, Co (II) sulfamate, Ni (II) sulfate, Fe (III) sulfate, Cu (II) sulfate, Co (II) sulfate, Cr (III) sulfate, or any combination thereof.

Embodiment 10. The method of any one of the preceding Embodiments, wherein the electrocatalyst precursor comprises an enabling metal.

Embodiment 11. The method of Embodiment 10, wherein the enabling metal is Fe, Co, Cu, or any combination thereof.

Embodiment 12. The method of any one of the preceding Embodiments, wherein the electrolyte comprises KOH or NaOH.

Embodiment 13. The method of any one of the preceding Embodiments, wherein the electrocatalyst precursor prepares an electrocatalyst selected from a hydrogen evolution catalyst, oxygen evolution electrocatalyst, bifunctional hydrogen/oxygen evolution electrocatalyst, or any combination thereof.

Embodiment 14. The method of any one of the preceding Embodiments, wherein the amount of electrocatalyst precursor is effective in improving electrode efficiency for electrolytic hydrogen and/or oxygen production.

Embodiment 15. The method of any one of the preceding Embodiments, wherein electrocatalyst is deposited simultaneously with a hydrogen evolution reaction or oxygen evolution reaction.

Embodiment 16. An alkaline electrolyzer comprising an electrode, an electrolyte comprising OH−, and an electrocatalyst precursor.

Embodiment 17. A reactor system comprising an alkaline electrolyzer and an electrocatalyst precursor reservoir having electrocatalyst precursor therein, wherein the electrocatalyst precursor reservoir is coupled to the alkaline electrolyzer and allows introduction of the electrocatalyst precursor into the alkaline electrolyzer.

Embodiment 18. The alkaline electrolyzer or reactor system of any one of the preceding Embodiments, wherein the electrocatalyst precursor comprises a metal nitrate, a metal sulfate, a metal acetate, a metal chloride, a metal sulfamate, or any combination thereof.

Embodiment 19. The alkaline electrolyzer or reactor system of any one of the preceding Embodiments, wherein the electrocatalyst precursor comprises Fe, Ni, Co, Cr, Cu, or any combination thereof.

Embodiment 20. The alkaline electrolyzer or reactor system of any one of the preceding Embodiments, wherein the electrocatalyst precursor is in solution.

Embodiment 21. The alkaline electrolyzer or reactor system of any one of the preceding Embodiments, wherein the electrocatalyst precursor is an aqueous solution of Fe (III) nitrate, Ni (II) nitrate, Co (II) nitrate, Cr (III) nitrate, Cu (II) nitrate, Fe (II) chloride, Ni (II) chloride, Co (II) chloride, Ni (II) acetate, Co (II) acetate, Ni (II) sulfamate, Fe (II) sulfamate, Co (II) sulfamate, Ni (II) sulfate, Fe (III) sulfate, Cu (II) sulfate, Co (II) sulfate, Cr (III) sulfate, or any combination thereof.

Embodiment 22. The alkaline electrolyzer or reactor system of any one of the preceding Embodiments, wherein the electrocatalyst precursor comprises an enabling metal.

Embodiment 23. The alkaline electrolyzer or reactor system of Embodiment 22, wherein the enabling metal is Fe, Co, Cu, or any combination thereof.

Embodiment 24. The alkaline electrolyzer or reactor system of any one of the preceding Embodiments, wherein the electrolyte comprises KOH or NaOH.

Embodiment 25. The alkaline electrolyzer or reactor system of any one of the preceding Embodiments, wherein the electrocatalyst precursor prepares an electrocatalyst selected from a hydrogen evolution catalyst, oxygen evolution electrocatalyst, bifunctional hydrogen/oxygen evolution electrocatalyst, or any combination thereof.

Embodiment 26. A composition comprising an electrolyte comprising OH− and an effective amount of an electrocatalyst precursor to improve electrode efficiency for electrolytic hydrogen and/or oxygen production.

### EXAMPLES

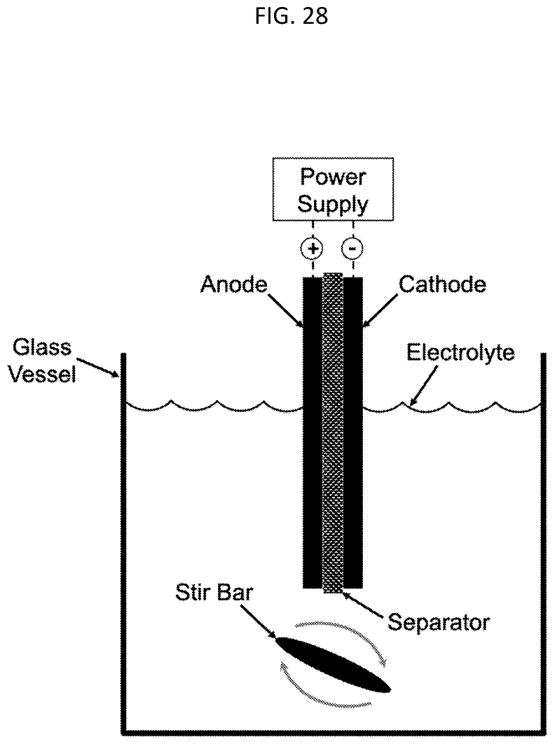

In all examples, aqueous solutions of the metal salts were prepared with a metal cation concentration of 0.2 M. In experiments using multiple metal nitrates, the nitrate solutions were combined in an equimolar ratio based on the metal ions unless specified otherwise. All examples, unless otherwise noted, were performed in an alkaline electrolysis test cell as shown in FIG. 28, with the anode electrode positive at 80° C. and atmospheric pressure. In all cases unless otherwise noted, a constant current density of 0.3 A cm⁻² was applied in a two-electrode system with Ni mesh electrodes and a Zirfon separator. After 30 minutes of operation, with the current still applied to the test cell, the aqueous metal salt solution was added at 2% v/v to the aqueous 30 wt % KOH while stirring. The current density of 0.3 A cm⁻² was maintained for 6 to 24 hours to grow catalyst structures on the electrode surface through reactive deposition while simultaneously producing hydrogen and oxygen. During operation, deionized water (18.2 MΩ-cm) was periodically added to replace water lost. After operation and deposition for 6 to 24 hours, the electrode assembly was removed from solution, disassembled, and rinsed with deionized water. The cathode and anode were peeled away from the Zirfon separator, and the separator-facing side of the cathode and anode were analyzed using scanning electron microscopy and energy dispersive x-ray spectroscopy.

### Example 1

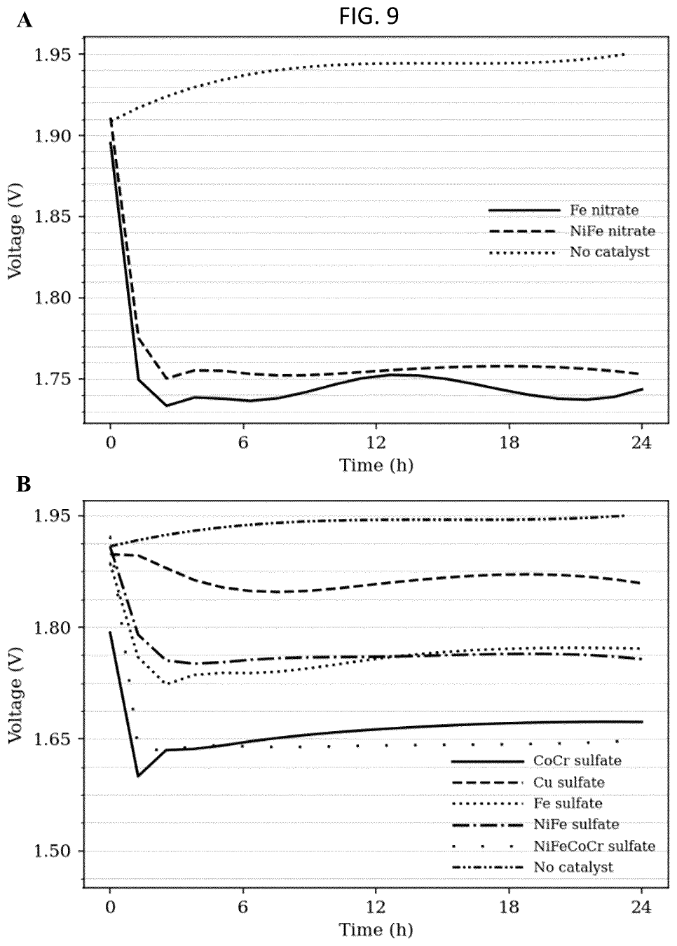

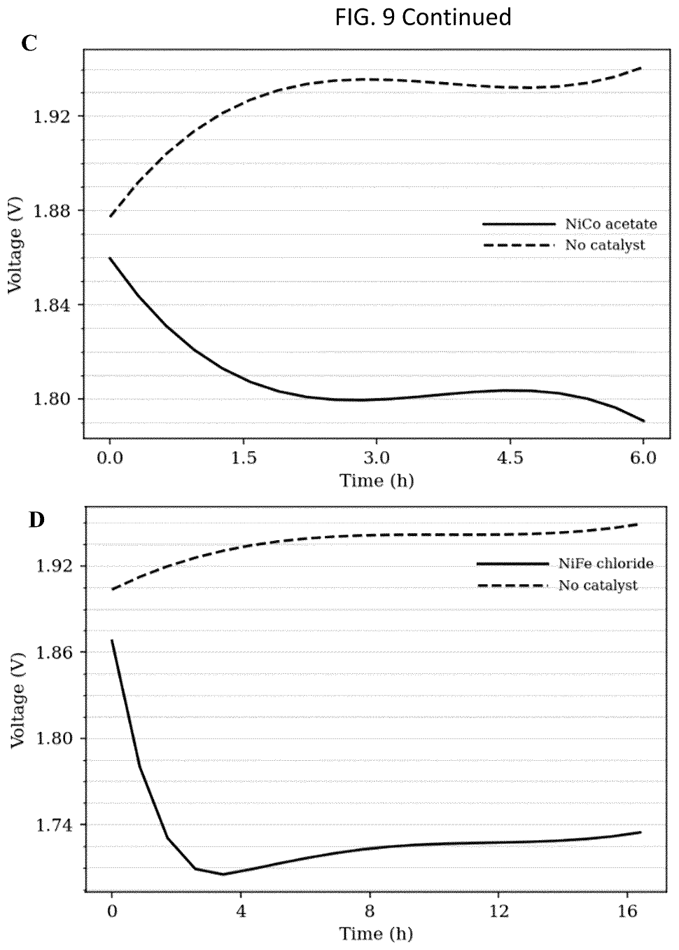

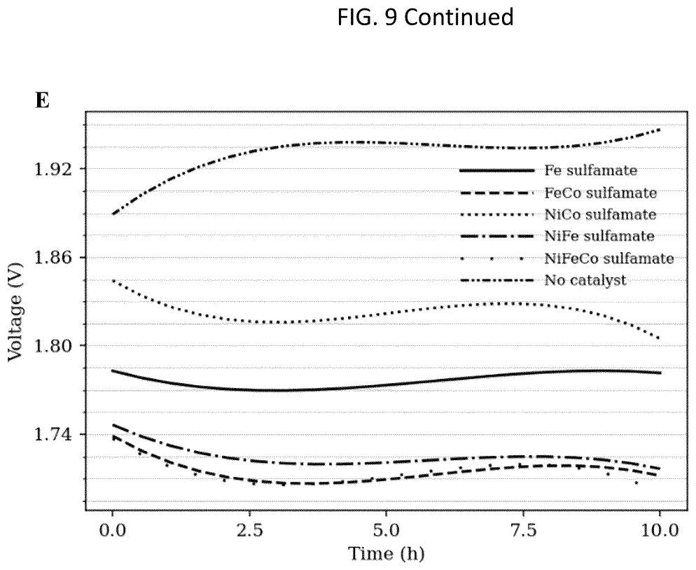

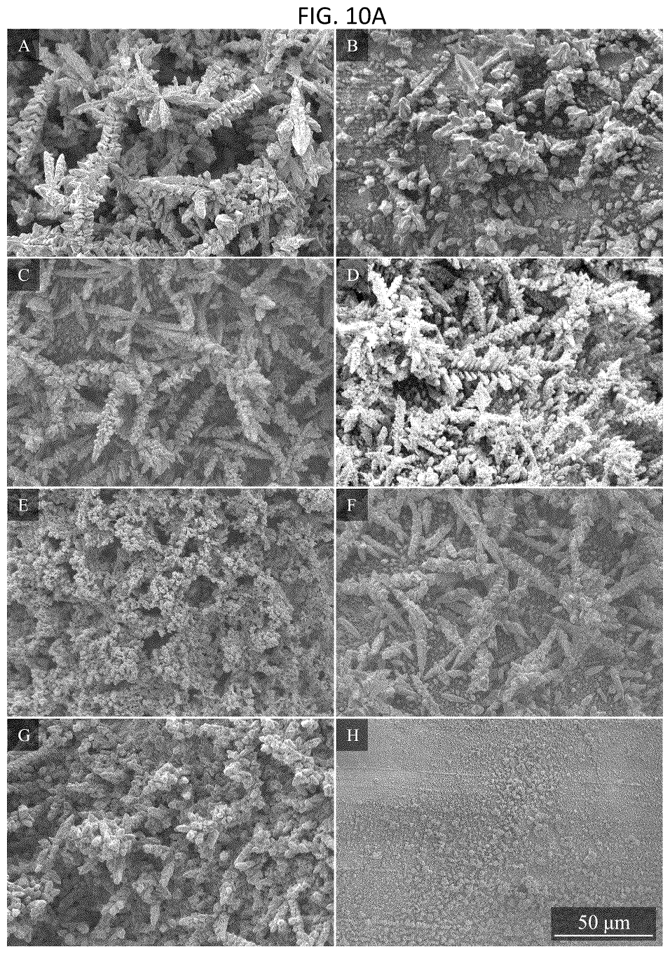

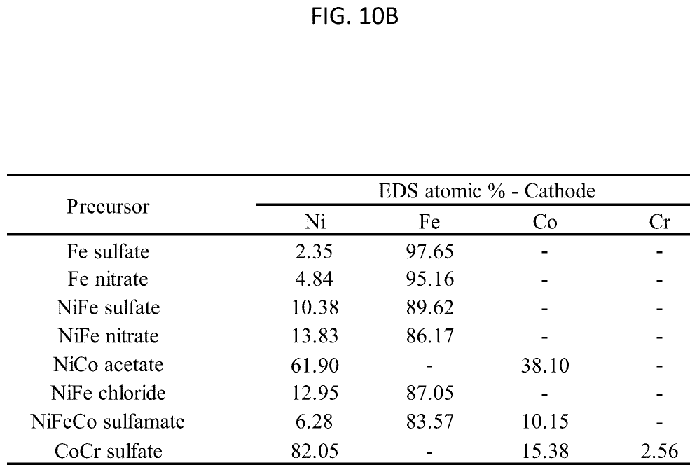

FIG. 9 demonstrates synthesizing catalyst via reactive deposition, in situ, using water-soluble precursors and applying current. FIG. 9 demonstrates that deposition is possible with metal nitrates, sulfates, acetates, chlorides, and sulfamates, in both single metal and mixed metal configurations. FIG. 10A shows the corresponding catalyst structures grown from select precursor(s). EDS measurements (FIG. 10B) show the composition of the catalyst structures. Catalyst structures formed without Ni precursors still show a percentage of Ni due to the Ni mesh substrate electrode.

FIG. 9A uses Fe (III) nitrate in a single metal configuration as well as a mixture of both Fe (III) nitrate and Ni (II) nitrate. When no catalyst is added to the KOH electrolyte, the voltage of bare Ni metal electrodes is in the range of 1.91 V to 1.95 V. Adding either Fe (III) nitrate alone or Fe (III) nitrate and Ni (II) nitrate together drops the voltage in the range of 1.74 V to 1.76 V (indicative of improved catalyst performance) and enables growth of catalyst structures on the surface of the electrode as shown in FIG. 10A(B) and FIG. 10A(D).

FIG. 9B demonstrates that a similar catalyst deposition occurs when sulfate is used as the counter ion instead. Adding Fe (III) sulfate alone or in combination with Ni (II) sulfate drops the voltage in the range of 1.75 V to 1.77 V. FIGS. 10A(A) and 10A(C) show deposited catalyst structures from each of these experiments. Co (II) sulfate, Cr (III) sulfate, Cu (II) sulfate, and/or Ni (II) sulfate are also shown to improve performance in various combinations. FIG. 10A(H) shows deposited catalyst structures after the addition of Co (II) sulfate and Cr (III) sulfate.

FIG. 9C demonstrates a similar process using a combination of Ni (II) acetate and Co (II) acetate. Adding this precursor mixture dropped the voltage to 1.79 V after 6 hours of applied current. FIG. 10A(E) shows deposited catalyst structures from this experiment.

FIG. 9D demonstrates reactive deposition using Ni (II) chloride and Fe (II) chloride. Adding this precursor mixture dropped the voltage to 1.74 V after 16 hours of applied current. FIG. 10A(F) shows deposited catalyst structures from this experiment.

FIG. 9E demonstrates reactive deposition using Ni (II) sulfamate, Fe (II) sulfamate, and Co (II) sulfamate in a variety of combinations. Experiments using Fe (II) sulfamate were prepared under an inert (N₂) atmosphere due to air sensitivity. In these experiments, precursors were added before current was applied, so the starting voltages are lower than typical baseline voltages. Adding these precursor mixtures dropped the voltages to a range of 1.71 V to 1.8 V after 10 hours of applied current. FIG. 10A(G) shows deposited catalyst structures after the addition of Ni (II) sulfamate, Fe (II) sulfamate, and Co (II) sulfamate.

### Example 2

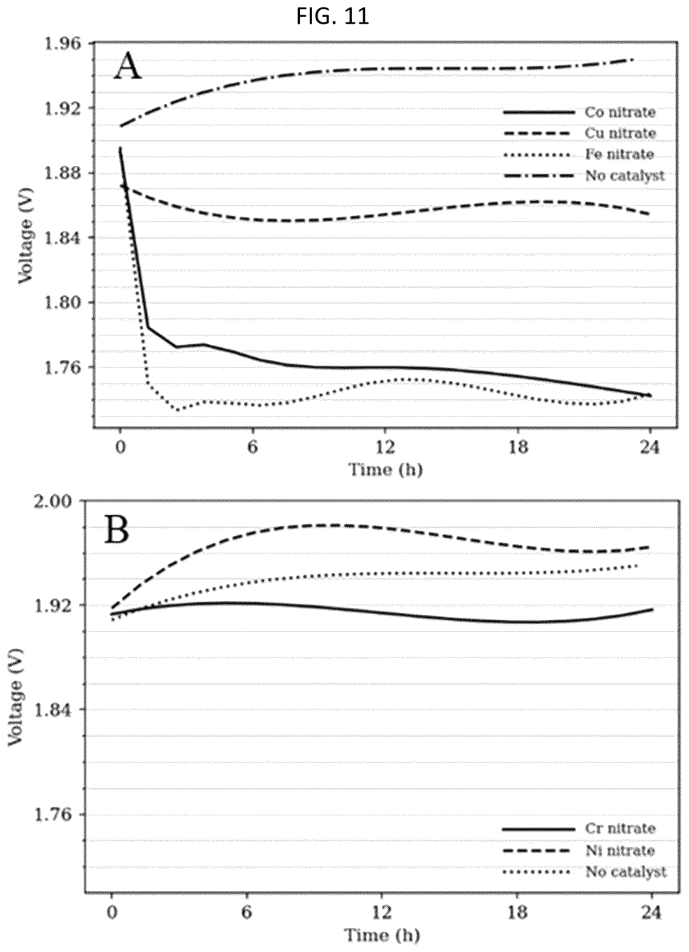

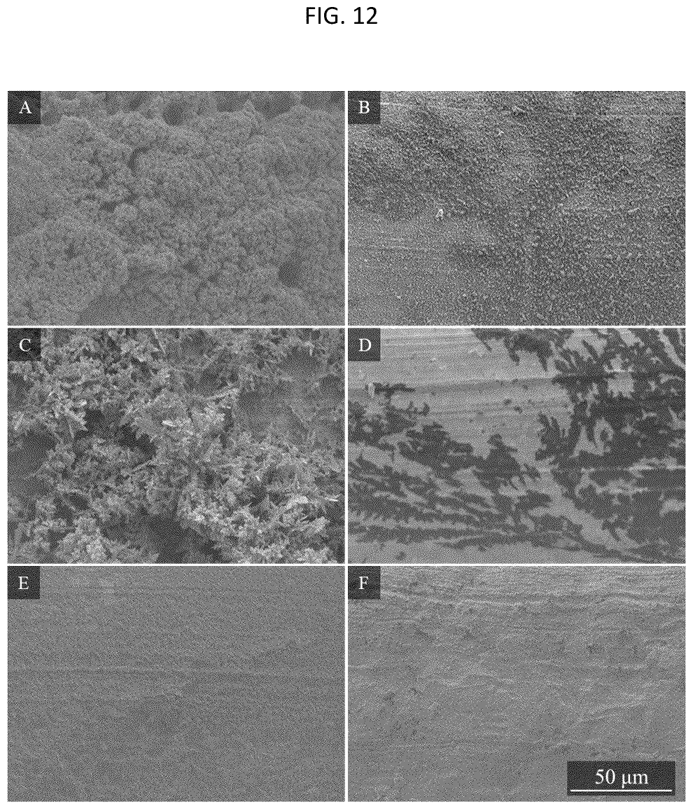

FIG. 11 demonstrates that for single metal compositions, certain metals will undergo in situ deposition, while other metals will not undergo in situ deposition. As shown in FIG. 11A, when no catalyst is added to the KOH electrolyte, the voltage of bare Ni metal electrodes is in the range of 1.91 V to 1.95 V (labeled No catalyst). When Fe (III) nitrate, Cu (II) nitrate, or Co (II) nitrate are added to the KOH electrolyte, the voltage drops in the range of 1.84 V to 1.87 V for Cu (II) nitrate or in the range of 1.75 V to 1.79 V for Fe (III) nitrate and Co (II) nitrate. The voltage drop when the metal nitrates are added to the KOH electrolyte indicates improved catalytic performance of the water splitting reactions. FIGS. 10B, 12A, and 12C show the in-situ deposition of the Fe-based catalyst, Co-based catalyst, and Cu-based catalyst respectively on the Ni mesh cathodes. FIG. 12B also shows the in-situ deposition of the Co-based catalyst on the Ni mesh anode. As shown in FIG. 11B, when either Ni (II) nitrate or Cr (III) nitrate are added to the KOH no significant change in voltage is measured compared to when no catalyst is added (all voltages in the range of 1.91 V to 1.97 V). In addition, SEM images (FIGS. 12D, 12E) of the cathodes of the Ni (II) nitrate and Cr (III) nitrate show that no significant amount of catalyst is deposited.

### Example 3

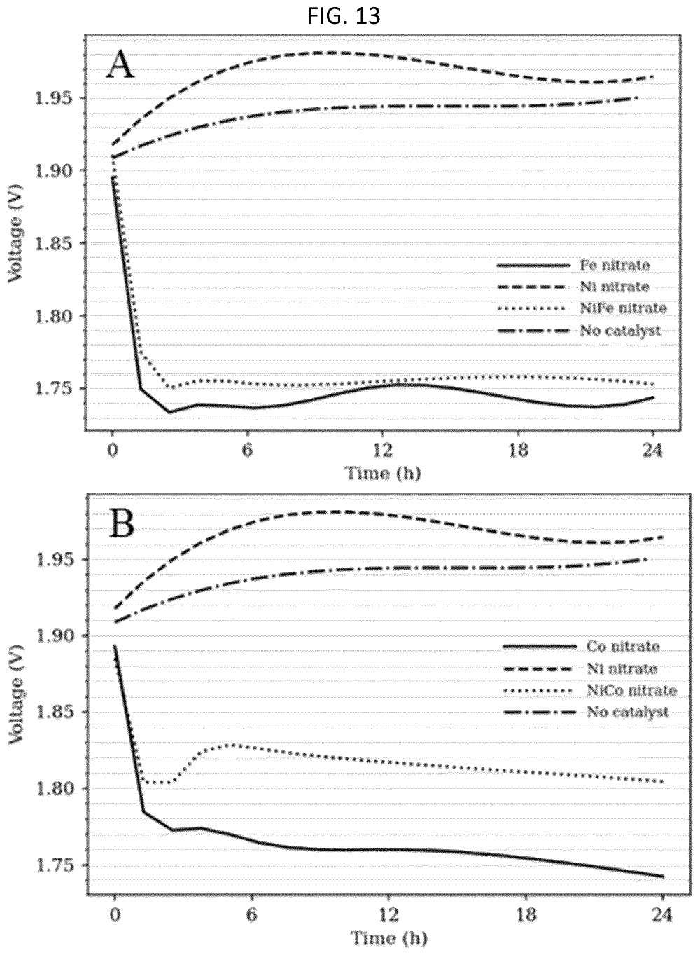

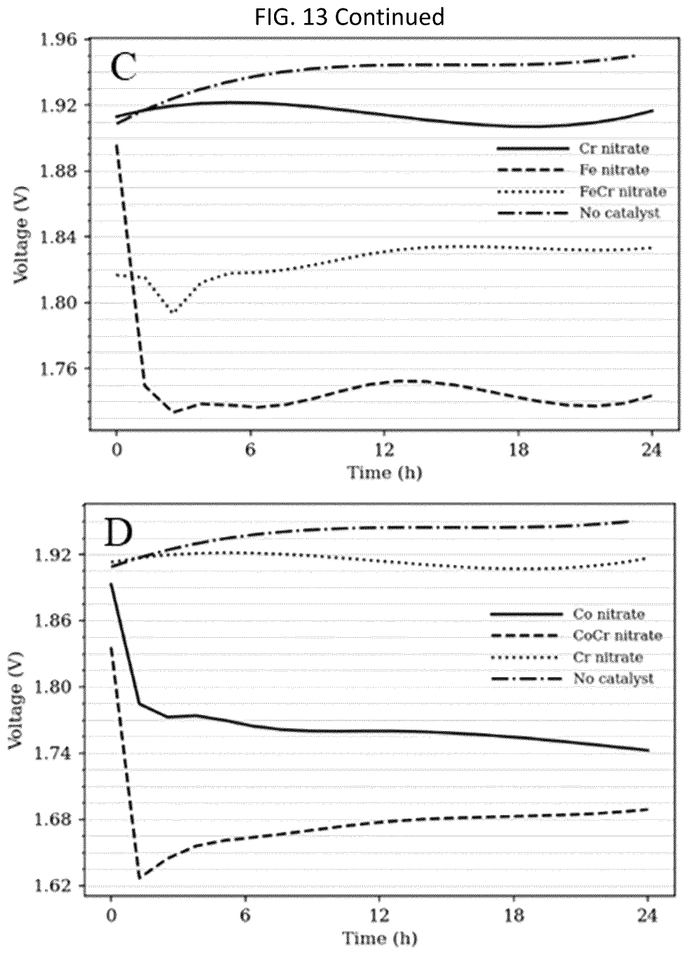

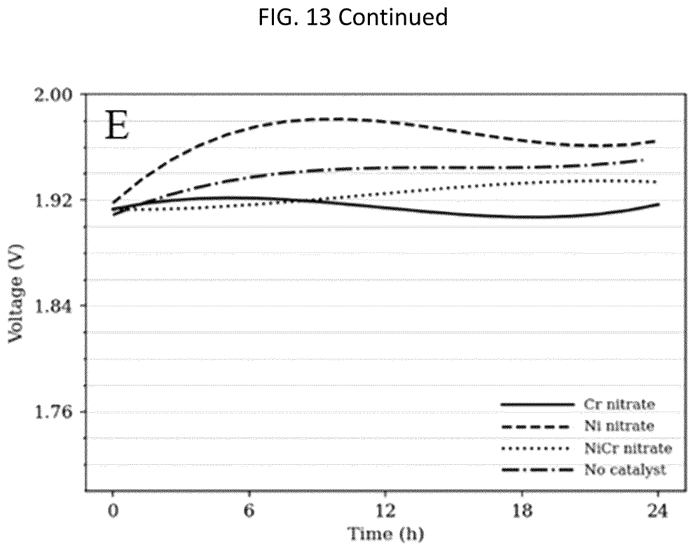

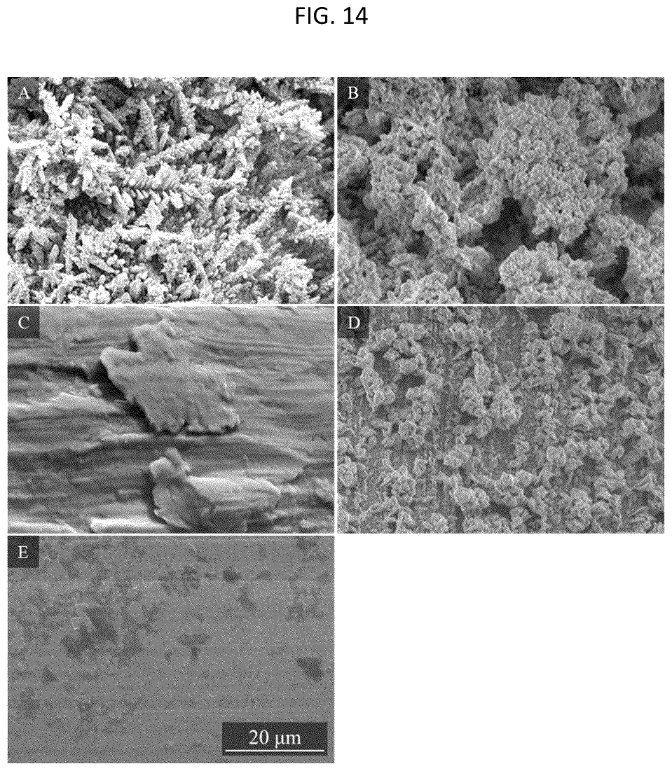

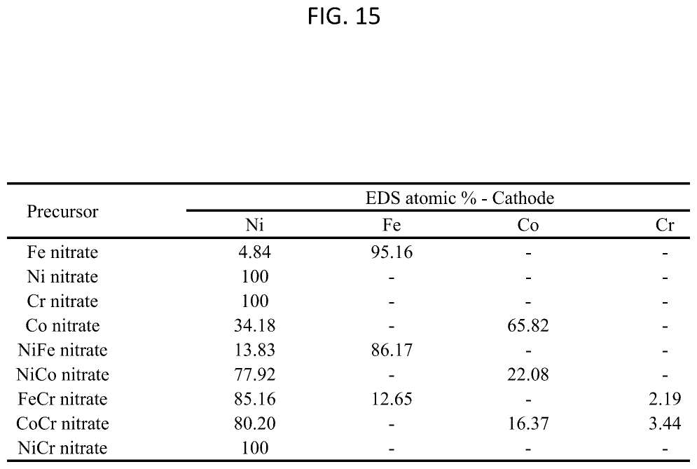

FIG. 13 demonstrates that in combinations of different metal precursors, the presence of certain metals (Fe and Co) will assist the deposition of metals that do not deposit in single-metal configurations. In all cases, the reduction of the cell voltage is indicative of catalyst depositing on the electrodes. FIG. 13A shows that Fe (III) nitrate assists the deposition of Ni (II) nitrate. FIG. 13B shows that Co (II) nitrate assists the deposition of Ni (II) nitrate. FIG. 13C shows that Fe (III) nitrate assists the deposition of Cr (III) nitrate. FIG. 13D shows that Co (II) nitrate assists the deposition of Cr (III) nitrate. FIG. 13E shows that no deposition occurs when Ni (II) nitrate and Cr (III) nitrate are used without Fe or Co. The co-deposition of the metals is confirmed by SEM and EDS measurements. For example, when Cr is deposited in a single-metal configuration, no Cr is detected in the EDS measurement. However, when Cr is co-deposited with Fe or Co, the Cr content measured in the EDS experiment is 2.19% and 3.44%, respectively (FIG. 15). SEM images show deposition for each combination containing Fe or Co (FIGS. 14A-D) and no deposition for the combinations without Fe or Co (FIG. 14E).

### Example 4

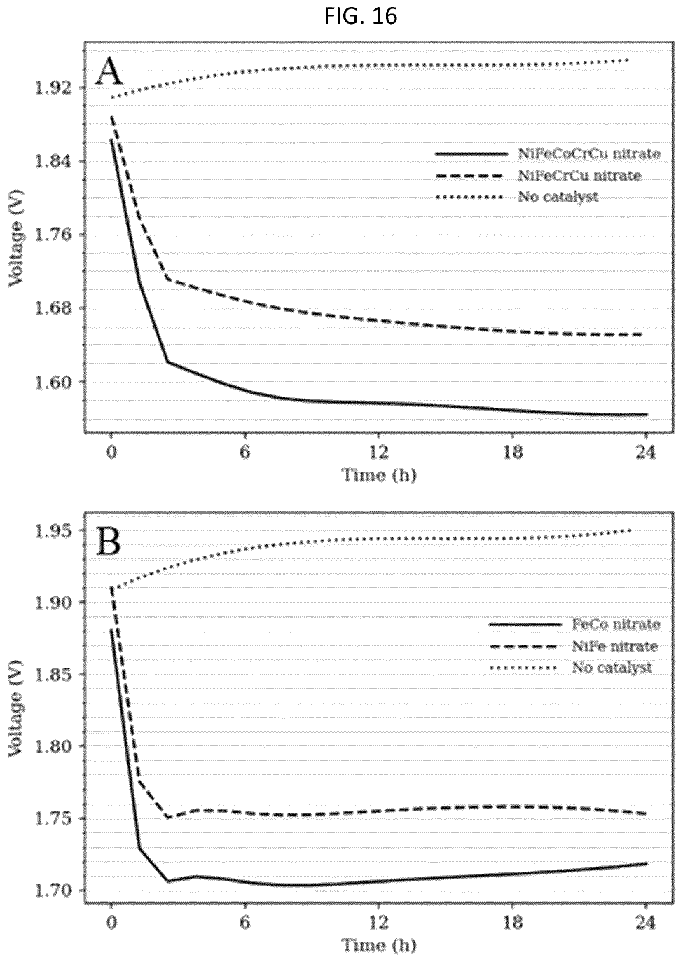

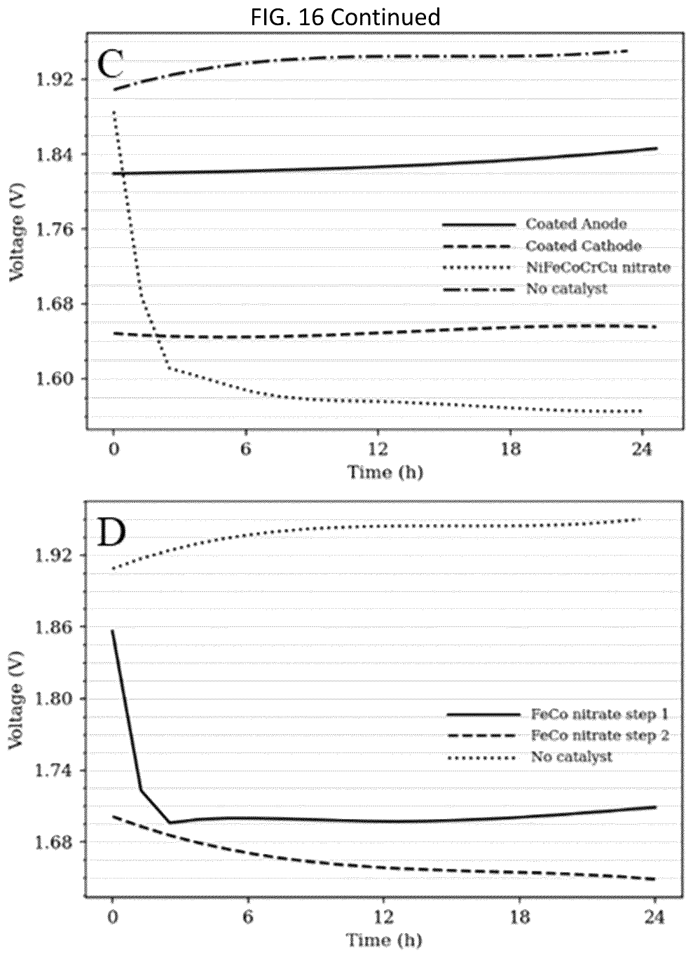

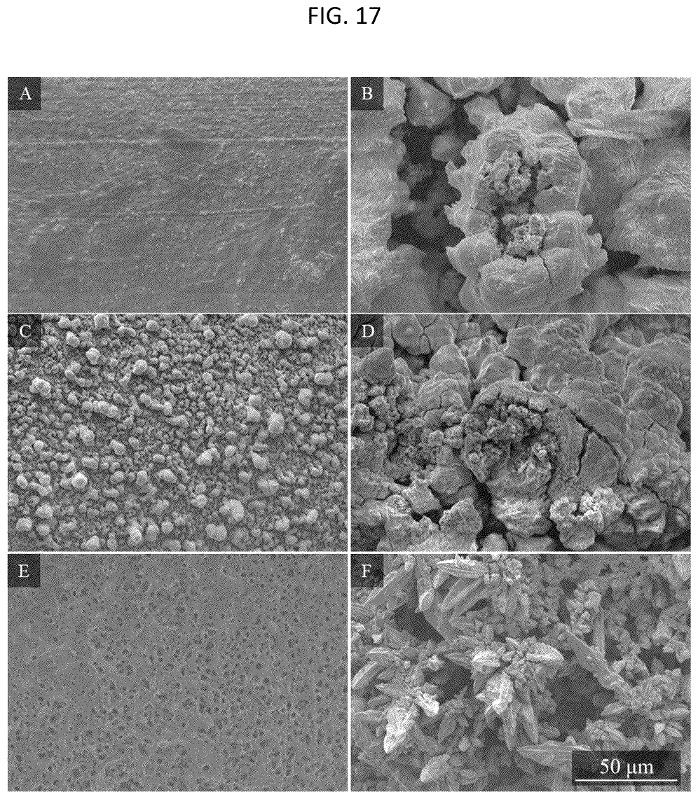

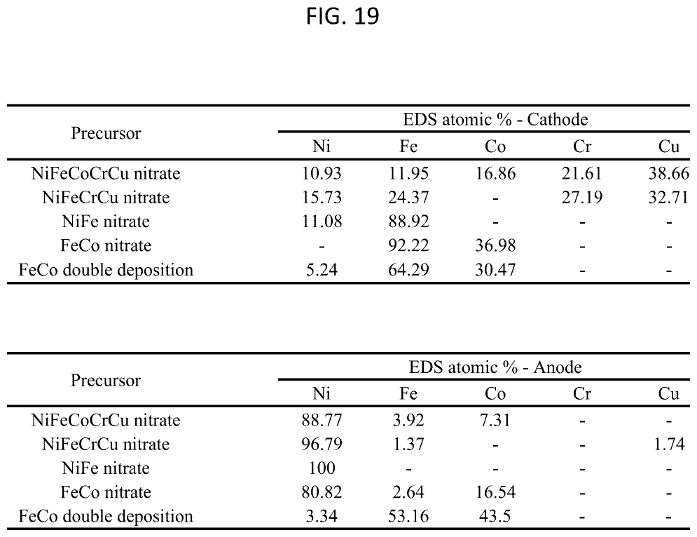

FIG. 16 demonstrates that some metals deposit primarily on the cathode, some metals will deposit on both the cathode and the anode, and that performance is improved when there is deposition on both electrodes. FIG. 16A shows an example of a mixed metal combination (Ni, Fe, Cr, and Cu nitrates) that deposits primarily on the cathode, with very little anode coating (FIGS. 17A and 17B) and a mixed metal combination (Ni, Fe, Cr, Cu, and Co nitrates) that deposits on both the anode and cathode (FIGS. 17C and 17D). FIG. 16A shows that the mixed metal combination that deposits more heavily on the anode dropped the voltage 80-100 mV lower than the combination that deposited mainly on the cathode. EDS measurements confirm the presence of metal species other than Ni on the anode (FIG. 19).

FIG. 16B shows another example of a metal combination that deposited mainly on the cathode (Ni and Fe nitrates, FIG. 10D) and one that deposited on both electrodes (Fe and Co nitrates, FIGS. 17E and 17F). The metal combination with catalyst on both electrodes lowered the voltage 30-50 mV more than the combination that only deposited on the cathode.

FIG. 16C shows an electrode assembly that was deposited using Ni, Fe, Co, Cr, and Cu nitrates. After the 24-hour deposition, the anode and electrode were split apart and paired with new nickel mesh counter electrodes. These electrode assemblies were then operated in clean electrolyte without added precursor with a current density of 0.3 A cm⁻² for 24 h. FIG. 16C shows the initial deposition (labeled “NiFeCoCrCu nitrate”), the coated anode paired with a clean cathode, and the coated cathode paired with a clean anode. The coated anode lowered the voltage ca. 100 mV from the baseline, and the coated cathode lowered the voltage ca. 300 mV from the baseline. This indicates both electrodes contribute to the improved performance seen in the full cell data.

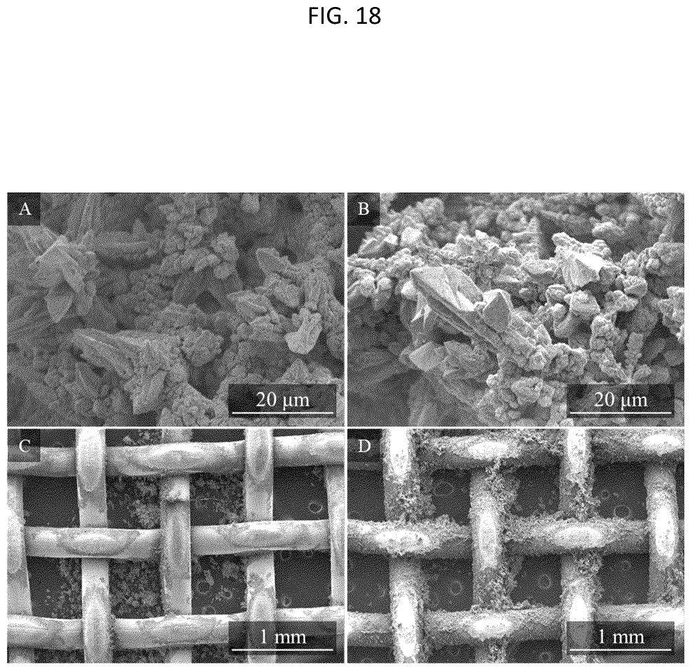

In another example, Fe and Co nitrates were deposited together on the anode and cathode of an assembly. After the initial 24-hour deposition, the cell was then put in a new aqueous 30 wt % KOH solution with reversed polarity (leads switched), where the anode in step 1 became the cathode in step 2, and the cathode in step 1 became the anode in step 2. The electrolyte was replaced with clean electrolyte for a second 24-hour deposition with a new injection of 2% v/v of Fe and Co nitrate. This two-step deposition dropped the voltage 60 mV lower than the single step deposition (FIG. 16D). The two-step deposition results in a non-uniform coating on the anode (FIGS. 18C and 18D), however, in areas where catalyst does form, the structures are similar on the anode and cathode (FIGS. 18A and 18B) unlike the single step deposition, where the structure of the anode and cathode coatings look different (FIGS. 17E and 17F).

### Example 5

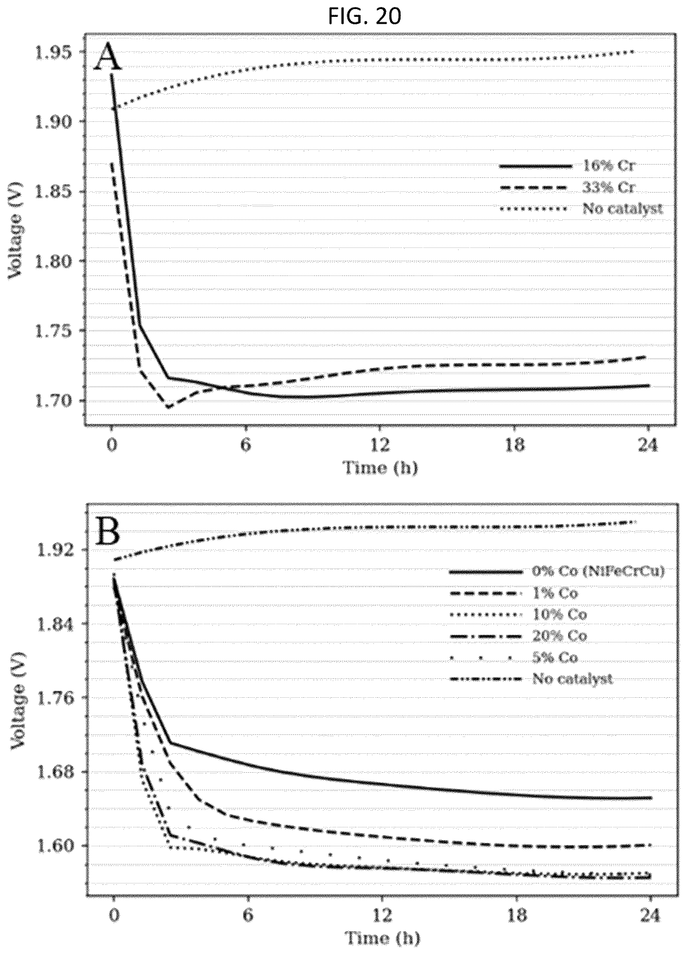

FIG. 20 demonstrates that different metal ratios of mixed-metal catalysts can be used to improve water splitting performance. FIG. 20A shows a comparison between depositions using two different Ni, Fe, and Cr nitrate precursor mixtures, one with 33% Cr in the added solution and a second with 16% Cr in the starting solution. The lower voltage for the 16% Cr sample is indicative of better water splitting performance. FIG. 20B shows examples from depositions using different Ni, Fe, Cr, Cu, and Co nitrate precursor mixtures, varying the amount of Co in the starting solution. Increasing the Co from 0% to 1% to 5% improved the water splitting performance, but no additional performance gains were measured moving from 5% to 10% to 20% Co.

### Example 6

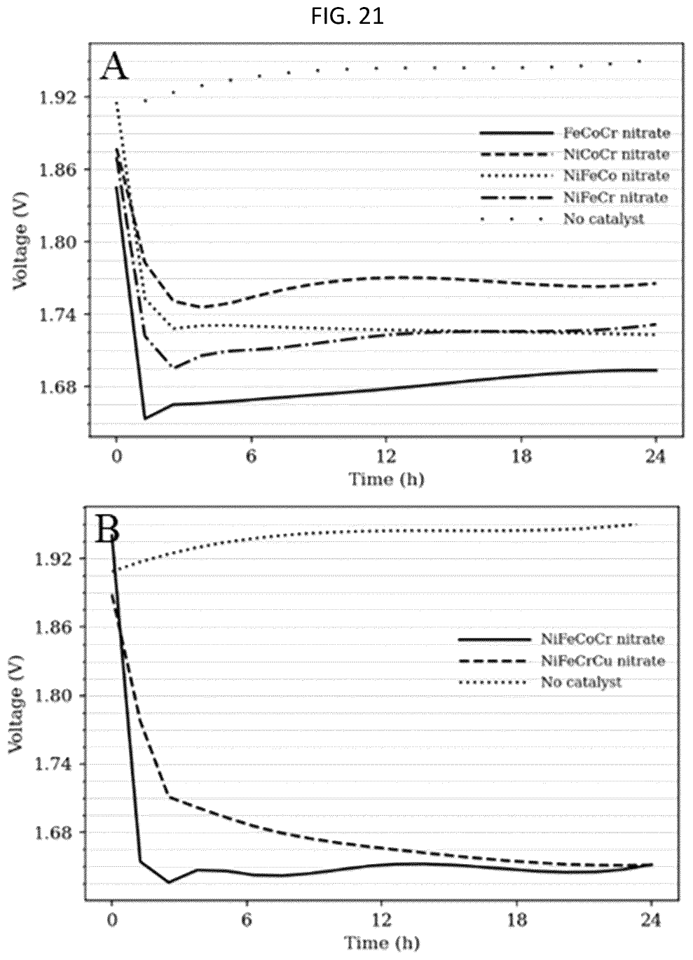

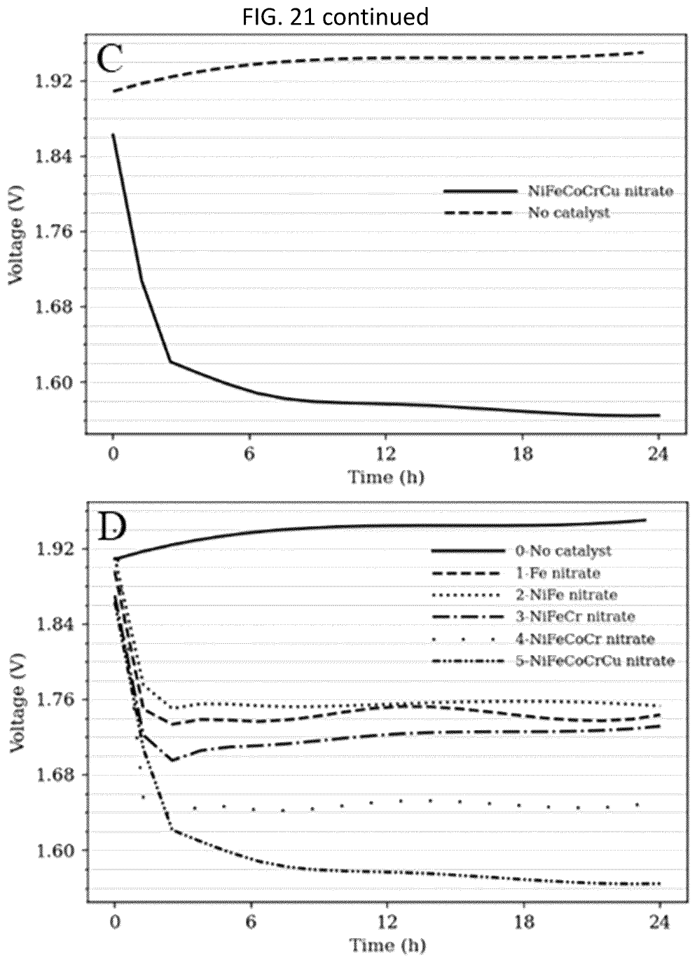

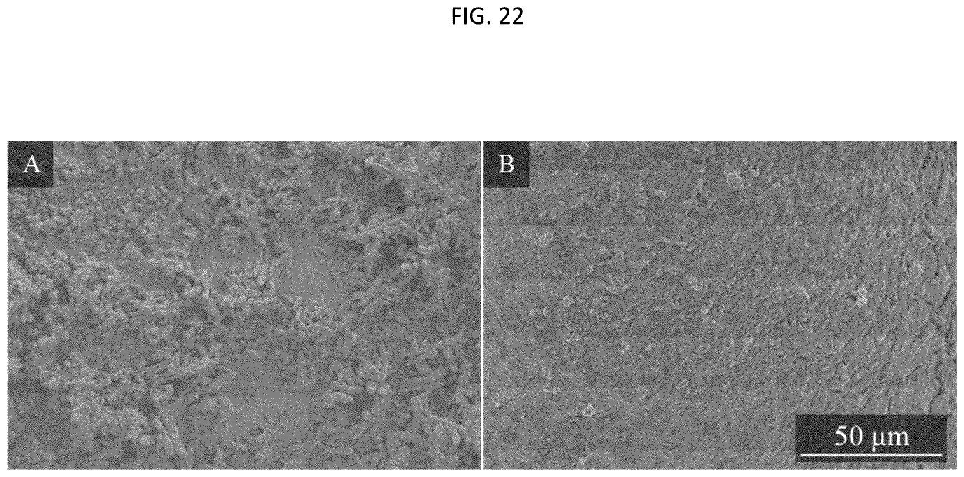

FIG. 21 demonstrates performance improvements using mixtures of metal precursors with 3 metal species (FIG. 21A, FIG. 22A-B), 4 metal species (FIG. 21B, FIG. 17A-B) and 5 metal species (FIG. 21C, FIG. 17C-D). FIG. 21D shows a series of progressive experiments with 0-5 metal components added to the electrolyte solution. Experiments with 3 metal components reduced the voltage to a range of 1.69 V to 1.77 V. Experiments with 4 metal components reduced the voltage even further to 1.66 V. An experiment with 5 metal components reduced the voltage down to 1.56 V, which is lower than any of the experiments conducted with fewer components.

### Example 7

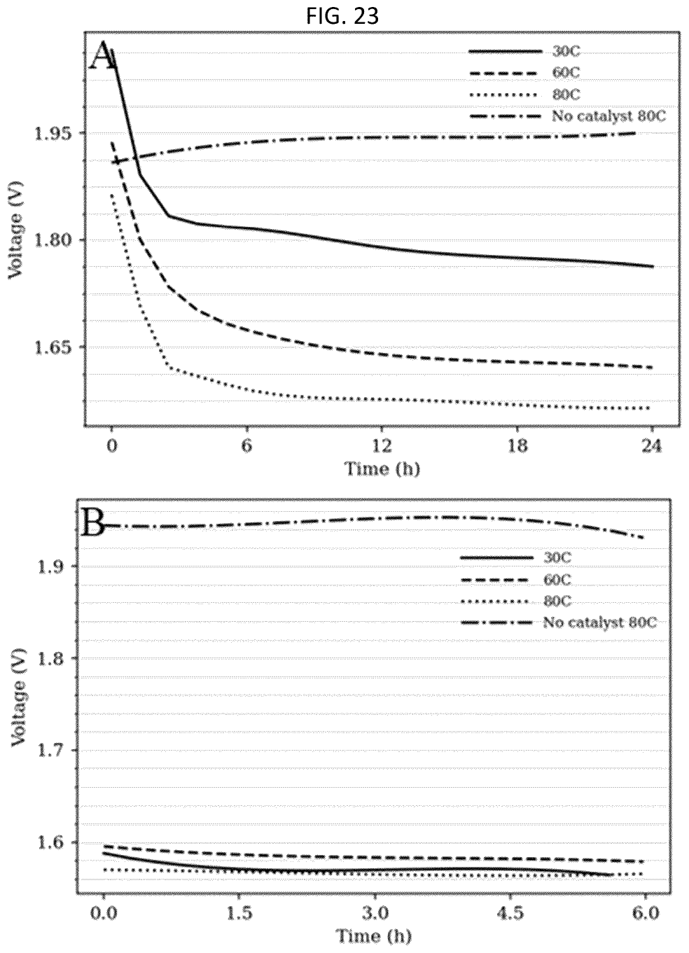

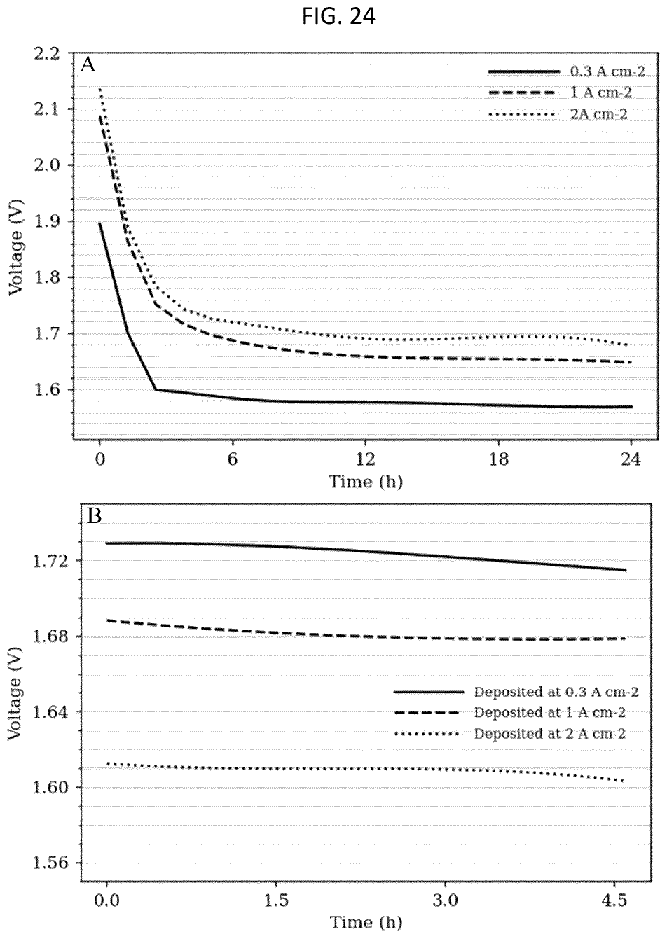

FIG. 23 demonstrates that the in situ synthesis and reactive deposition occurs at a range of temperatures. In situ synthesis and deposition was carried out at 30° C., 60° C., and 80° C. (FIG. 23A), then the test cells were heated to 80° C. to compare performance after the initial deposition (FIG. 23B). All three temperatures showed a drop in voltage over the course of the 24 h run, which is indicative of in situ deposition. When operated at 80° C., cells at all three temperatures performed similarly with a voltage range of 1.56-1.60 V.

### Example 8

FIG. 24 demonstrates that the in situ reactive deposition process works at a range of applied current densities. Depositions were carried out at 0.3 A cm⁻², 1 A cm⁻², and 2 A cm⁻² (FIG. 21A). At the end of the 24-hour deposition, the electrolyte solution was exchanged for clean electrolyte without added catalyst precursors, and the electrolyzers were operated at 1 A cm⁻² for 4.5 hours to compare performance (FIG. 21). Deposition at all three current densities resulted in a decrease in voltage compared to baseline cells at those current densities (FIG. 24C), indicating that reactive deposition occurred in each case. During operation at 1 A cm⁻², the electrode assembly that was deposited at 2 A cm⁻² had the greatest improvement in performance.

### Example 9

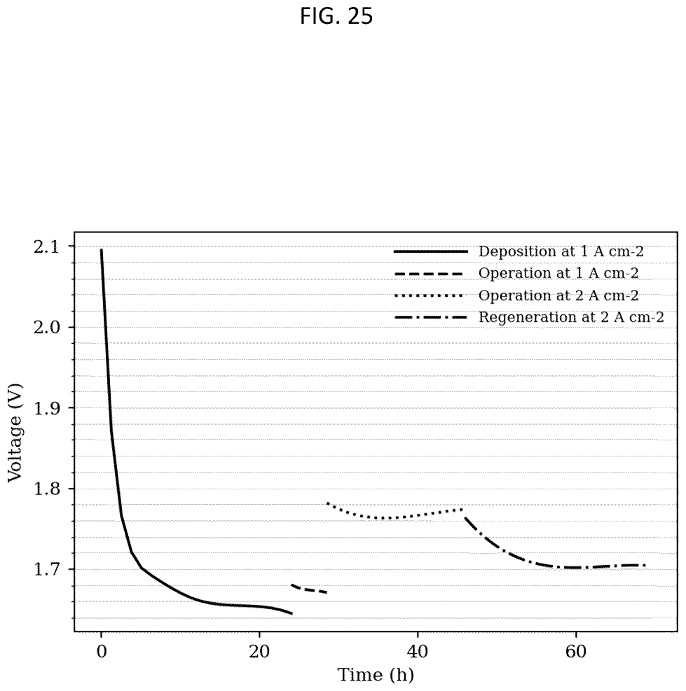

FIG. 25 demonstrates that a cell deposited in situ using metal nitrate precursors will continue to perform in clean electrolyte after the initial deposition. In addition, after operating for a period of time, the catalyst coating can be regenerated by adding more metal nitrate precursor into the system. FIG. 25 shows an experiment with a deposition using Ni, Fe, Co, Cr, and Cu nitrate precursors. After 24 h deposition at 1 A cm⁻², the electrolyte solution was replaced with clean 30 wt % KOH without added precursors and the cell was run at 1 A cm⁻² for 4.5 hours (ca. 1.67 V), then 2 A cm⁻² for 22.5 hours (ca. 1.77 V), at which point Ni, Fe, Co, Cr, and Cu nitrate precursor mixture was added again to the electrolyte. The resulting drop in voltage indicates regeneration of the catalyst coating.

### Example 10

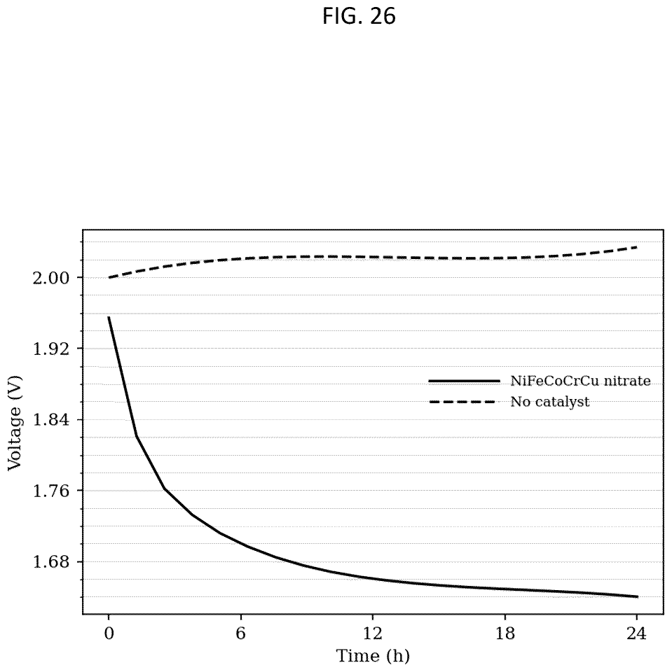

FIG. 26 demonstrates that in situ catalyst synthesis and in situ reactive deposition can be performed in multiple electrolyte solutions. In this example, aqueous 20 wt % NaOH was used as the electrolyte and the cell was operated at 65° C. As shown in FIG. 26, when no catalyst precursor is added to the NaOH electrolyte, the voltage of bare Ni mesh electrodes is in the range of 2.00 V to 2.04 V. Adding in a solution of Ni, Fe, Co, Cr, and Cu nitrate precursors reduces the voltage to 1.64 V, indicating that the performance has improved from in situ catalyst synthesis and deposition.

### Example 11

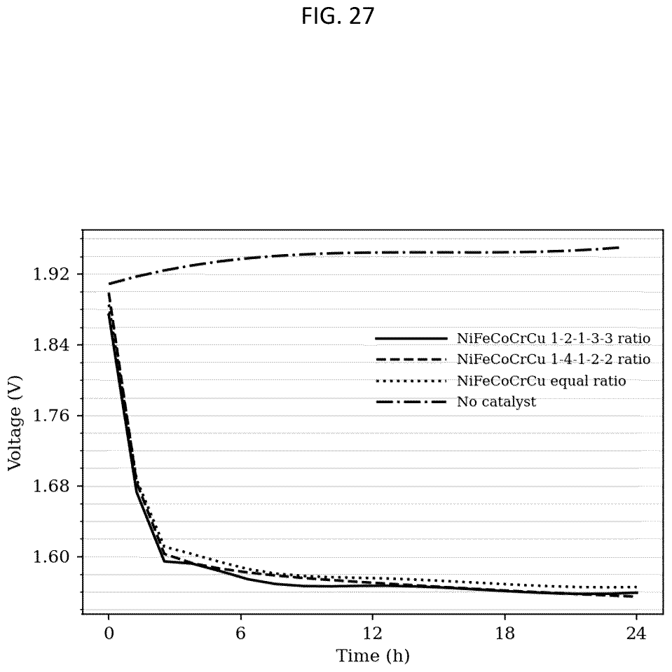

FIG. 27 demonstrates the current best performing catalysts synthesized in situ from metal nitrate precursors in a variety of compositions by atomic ratio of the metals included. One precursor was 20% each of Ni, Fe, Co, Cr, and Cu nitrates. One precursor was 10% Ni, 20% Fe, 10% Co, 30% Cr, and 30% Cu nitrates. One precursor was 10% Ni, 40% Fe, 10% Co, 20% Cr, and 20% Cu nitrates. All three mixtures had similar performance and reduced the voltage to a range of 1.55 V-1.57 V. This indicates that the in-situ synthesis and reactive deposition process works with a variety of precursor compositions, which can be optimized for cost or performance.

We claim:

1. A method for depositing electrocatalysts, the method comprising:
introducing into an alkaline electrolyzer an electrocatalyst precursor, wherein the alkaline electrolyzer has an electrolyte comprising OH⁻ and one or more electrodes or
mixing an electrocatalyst precursor with an electrolyte comprising OH− and contacting the resulting mixture with one or more electrodes having a current applied thereto.

2. The method of claim 1, wherein a current is applied to the one or more electrodes during introduction of the electrocatalyst precursor.

3. The method of claim 1, wherein a current is applied to the one or more electrodes prior to and during introduction of the electrocatalyst precursor without interrupting application of the current to the one or more electrodes.

4. The method of claim 1, comprising mixing an electrocatalyst precursor with the electrolyte comprising OH⁻ and contacting the resulting mixture with the one or more electrodes having a current applied thereto.

5. The method of claim 4, wherein the electrocatalyst precursor and the electrolyte are mixed in an alkaline electrolyzer comprising the one or more electrodes having the current applied thereto.

6. The method of claim 1, wherein the electrocatalyst precursor comprises a metal nitrate, a metal sulfate, a metal acetate, a metal chloride, a metal sulfamate, or any combination thereof.

7. The method of claim 1, wherein the electrocatalyst precursor comprises Fe, Ni, Co, Cr, Cu, or any combination thereof.

8. The method of claim 1, wherein the electrocatalyst precursor is in solution.

9. The method of claim 1, wherein the electrocatalyst precursor is an aqueous solution of Fe (III) nitrate, Ni (II) nitrate, Co (II) nitrate, Cr (III) nitrate, Cu (II) nitrate, Fe (II) chloride, Ni (II) chloride, Co (II) chloride, Ni (II) acetate, Co (II) acetate, Ni (II) sulfamate, Fe (II) sulfamate, Co (II) sulfamate, Ni (II) sulfate, Fe (III) sulfate, Cu (II) sulfate, Co (II) sulfate, Cr (III) sulfate, or any combination thereof.

10. The method of claim 1, wherein the electrocatalyst precursor comprises an enabling metal.

11. The method of claim 1, wherein the electrolyte comprises KOH or NaOH.

12. The method of claim 1, wherein the electrocatalyst precursor prepares an electrocatalyst selected from a hydrogen evolution catalyst, oxygen evolution electrocatalyst, bifunctional hydrogen/oxygen evolution electrocatalyst, or any combination thereof.

13. The method of claim 1, wherein the electrocatalyst is deposited simultaneously with a hydrogen evolution reaction or oxygen evolution reaction.

14. An alkaline electrolyzer comprising an electrode, an electrolyte comprising OH−, and an electrocatalyst precursor.

15. The alkaline electrolyzer of claim 14, wherein the electrocatalyst precursor comprises a metal nitrate, a metal sulfate, a metal acetate, a metal chloride, a metal sulfamate, or any combination thereof.

16. The alkaline electrolyzer of claim 14, wherein the electrocatalyst precursor comprises Fe, Ni, Co, Cr, Cu, or any combination thereof.

17. The alkaline electrolyzer of claim 14, wherein the electrocatalyst precursor is in solution.

18. The alkaline electrolyzer of claim 14, wherein the electrocatalyst precursor is an aqueous solution of Fe (III) nitrate, Ni (II) nitrate, Co (II) nitrate, Cr (III) nitrate, Cu (II) nitrate, Fe (II) chloride, Ni (II) chloride, Co (II) chloride, Ni (II) acetate, Co (II) acetate, Ni (II) sulfamate, Fe (II) sulfamate, Co (II) sulfamate, Ni (II) sulfate, Fe (III) sulfate, Cu (II) sulfate, Co (II) sulfate, Cr (III) sulfate, or any combination thereof.

19. The alkaline electrolyzer of claim 14, wherein the electrocatalyst precursor comprises an enabling metal.

20. The alkaline electrolyzer of claim 19, wherein the enabling metal is Fe, Co, Cu, or any combination thereof.
